(19) United States
(12) Patent Application Publication
(10) Pub. No.: US 2025/0383218 A1
(43) Pub. Date: Dec. 18, 2025

(54) METHOD FOR ITERATIVELY CREATING A MATRIX FROM BASE ELEMENTS

(71) Applicant: POLDI Microelectronics GmbH, Recklinghausen (DE)

(72) Inventor: Günter GRAU, Dorsten (DE)

(21) Appl. No.: 19/144,493

(22) PCT Filed: Dec. 29, 2023
(86) PCT No.: PCT/EP2023/088013

§ 371 Date: Aug. 19, 2025

(30) Foreign Application Priority Data
Jan. 1, 2023 (EP) 23000002.8

(51) Int. Cl. G01D 5/34; G01J 4/04

(52) U.S. Cl. CPC G01D 5/344; G01J 4/04

(57) ABSTRACT

A method for iteratively generating a matrix of base elements that includes forming at least one base matrix, applying modification operators iteratively, which are able to transform the base matrix or any matrix arising therefrom into a modified matrix, applying expansion operators iteratively, which form a larger matrix from a plurality of optionally modified smaller matrices from the preceding iteration by copying, rotation or reflection by virtue of parts of the larger matrix being filled with the optionally modified smaller matrices, performing virtual experiments within the scope of which the properties of a created matrix are examined by systematic creation of values deliberately containing errors from which an error signal is derivable, and in order to create a complex matrix, forming all permutations of next larger matrices by applying expansion operators and then evaluating by means of virtual experiments, the next larger matrices selected with the smallest error signals, and then forming the next larger matrices successively therefrom by applying expansion operators and evaluating by means of virtual experiments until the error signal drops below a given limit.

### BACKGROUND OF INVENTION

### Field of Invention

The present invention relates to a method for iteratively generating a matrix of base elements, wherein the base elements can be sensors or antennas with specific properties or different orientations, as well as electronic components with different circuitry, and to an arrangement of a plurality of four different base elements into an 8×8 matrix, and an arrangement of a plurality of four different base elements into a 16×16 matrix, and an arrangement of a plurality of four different base elements into a 32×32 matrix, and integrated circuits for measuring the polarization of light.

### Brief Description of Related Art

The known prior art (DE 102005031966 A1, EP 1902334 A1), which is the starting point of the invention, relates to a method for iteratively generating a matrix of base elements, wherein the base elements can be sensors or antennas with specific properties or different orientations, as well as electronic components with different circuitry.

The invention relates to arrangements of elements, in particular sensors, with reduced influence of unwanted variables such as, for example, unevenly spatially distributed signal strength or production gradients, as well as to methods for producing such arrangements. These arrangements are used, for example, in the field of polarization, colorimetry and magnetic field measurement.

Polarization angle sensors have a great advantage over optical encoders, as due to their using an unstructured polarization filter as a rotary encoder they are insensitive to mechanical tolerances and vibration. The basic measuring principle, based on the Malus law, can be demonstrated with just one polarization-sensitive single sensor. It is only able to be used in practice when at least two sensors are used, each of which responds to a different polarization direction. A particularly favorable arrangement results from four filters each rotated by 45° (DE 102005031966 A1, EP 1902334 A1). The advantage obtained is that the four signals form a differential quadrature signal. When the polarization plane of the incident light is rotated, sine and cosine signals are generated which can be analyzed independently of the brightness of the incident light.

However, this simple arrangement still has the disadvantage that it delivers an incorrect signal under non-uniform illumination, because the differently oriented sensor fields are then irradiated to different degrees. This effect cannot be easily distinguished from the corresponding polarization information. For example, surrounding brightness sensors could be used to determine a linear brightness gradient as well as its magnitude and direction and take this into account in the signal evaluation. However, this is not possible with a largely non-uniform illumination with non-linear gradients, such as the illumination profile of an LED.

In order to reduce the error caused by brightness gradients, the entire desired sensor surface can be divided into smaller partial sensors and the different partial sensors can be appropriately distributed. This is a very common process in electronics, which is also used, for example, for matching differential amplifiers (cross-coupled pairs) or for arranging current sources in a DAC. The gradients in this case are fabrication-related gradients in component parameters or system-related gradients of temperature, voltages on conductor tracks, etc.

The distribution of the partial sensors is governed by similar, but not the same, rules as for the placement of matching transistors, for example. For the placement of e.g. transistors of a differential amplifier or the power sources of a DAC, the influence of fabrication, such as gradients across the wafer, must be minimized. These normally remain constant over the service life, assuming constant operating conditions. It is also usually assumed that the circuit is small and a weak gradient extends over a large range, so that usually only linear gradients are compensated. In particular, it is often not assumed that a local maximum with a variable position will be reached on the circuit area to be compensated. This is often the case with sensors.

In the case of the polarization sensor, the problem is primarily that of the influence of unknown brightness distributions across the sensor surface, i.e. a quantity that can also change in the course of a single measurement. In particular in the case of miniaturized superstructures, much larger changes are to be expected in a small space, for example if the light of a light-emitting diode illuminates only a little more than the sensor surface, the illumination is not correctly aligned (offset), or design features of the light source (e.g. central bonding wire of an LED) or optics lead to locally bounded changes in brightness. Dust particles anywhere in the system can also cause similar errors.

Therefore, some other criteria must be used as a basis for optimizing the structure of a sensor or other elements in an array. For the illumination with an LED, for example, its beam profile is of interest, together with the question of how much the illumination of the sensor due to this LED changes with location and how the sensor signals can be distributed as uniformly as possible. In this regard it is a challenge to improve the known state of the art. The object addressed by the invention is to configure and refine the known method for iteratively creating a matrix in such a way that further optimization is achieved with regard to the aforementioned challenge.

### BRIEF SUMMARY OF THE INVENTION

This object is achieved by a method for iteratively generating a matrix of base elements, wherein base elements can be sensors or antennas with specific properties or different orientations, as well as electronic components with different circuitry, wherein:
at least one base matrix containing at least all base elements once is formed first, but which may also contain empty elements, namely positions that are not occupied by one of the base elements,
modification operators, such as rotation and reflection, are applied iteratively, which can transform the base matrix or any matrix arising therefrom into a modified matrix,
expansion operators, which form a larger matrix from a plurality of optionally modified matrices from the preceding iteration by copying, rotation or reflection by virtue of parts of the larger matrix being filled with the optionally modified smaller matrices, are applied iteratively,
virtual experiments are performed, within the scope of which the properties of a created matrix are examined by the systematic creation of values deliberately containing errors, from which an error signal can be derived, and
in order to create a complex matrix, all permutations of next larger matrices are first formed by applying expansion operators and evaluated by means of virtual experiments, then the next larger matrices with the smallest error signals are selected, and next larger matrices are then formed successively therefrom by applying expansion operators and are evaluated by means of virtual experiments until the error signal drops below a given limit.

The fundamental consideration is to arrange different base elements of an arrangement, such as a sensor array, in such a way that the sensitivity to local disturbances, such as fluctuations in intensity, is minimized. For this purpose, a method is also described, by means of which such arrangements can be generated efficiently.

As an example, the sensor array of a polarization-based angle of rotation sensor may consist of the N base element types, e.g. N=1,2,3,4, the individual polarization axis alignment of which relative to a selected reference is, for example, 0°, 45°, 90° and 135° in order to generate a differential quadrature signal. A similar configuration is obtained for various types of magnetic sensors following magnetoresistive effects, provided that these are 180° periodic, similar to the polarization measurement. For base elements that produce a 360° periodic signal, such as Hall sensors, the individual orientation would be more likely chosen to be 0°, 90°, 180° and 270°. With regard to the matrices shown here, the elements 1,3 and 2,4 should preferably be oriented orthogonal to each other. In general, however, the assignment of the number to the selected orientation or sensor type is arbitrary. Various color filters can also be arranged according to the invention in such a way that the color measurement is as insensitive as possible to the structure of the incident light. The concept can also be applied in the case of a Bayer pattern (BGGR), where the green filter is present twice and thus assigned two indices.

Specifically, it is proposed
that a base matrix is first formed which contains at least all base elements once, but which can also contain empty elements, namely positions which are not occupied by one of the base elements,
that modification operators, such as rotation and reflection, are applied iteratively, which can transform the base matrix or any matrix arising therefrom into a modified matrix,
that expansion operators, which form a larger matrix from a plurality of optionally modified matrices from the preceding iteration by copying, rotation or reflection by virtue of parts of the larger matrix being filled with the optionally modified smaller matrices, are applied iteratively,
that virtual experiments are performed, within the scope of which the properties of a created matrix are examined by the systematic creation of values deliberately containing errors from which an error signal can be derived, and
that in order to create a complex matrix, all permutations of next larger matrices are first formed by applying expansion operators and evaluated by means of virtual experiments, the next larger matrices with the smallest error signals being subsequently selected so that larger matrices are then formed successively therefrom by applying expansion operators and then evaluated by means of virtual experiments until the error signal drops below a given limit.

According to a further teaching, which has independent meaning, an arrangement of a plurality of four different base elements (1,2,3,4) into an 8×8 matrix is claimed.

Reference may therefore be made to all the comments in relation to the proposed method for iteratively creating a matrix.

According to a further teaching, which has independent meaning, an arrangement of a plurality of four different base elements (1,2,3,4) into a 16×16 matrix is claimed.

Reference may therefore be made to all the comments in relation to the proposed method for iteratively creating a matrix and the proposed arrangement.

According to a further teaching, which has independent meaning, an arrangement of a plurality of four different base elements (1,2,3,4) into a 32×32 matrix is claimed.

Reference may therefore be made to all the comments in relation to the proposed method for iteratively creating a matrix and the respective proposed arrangement.

According to the embodiment it can be provided that a larger array is created from the smaller arrays by means of copying, rotation or reflection operations.

According to the embodiment, individual positions of the matrix-like arrangement remain unoccupied.

According to a further teaching, which also has independent meaning, an integrated circuit for measuring the polarization of light is claimed
having polarization-sensitive sensors with at least two different orientations of the polarization planes,
wherein in the integrated circuit, devices are provided which are configured to make a statement about the polarization of the incident light from the signals of the polarization-sensitive sensors,
having at least one sensory element which is arranged to cooperate as a structural unit with a polarization filter for one of the polarization-sensitive sensors,
wherein the polarization-sensitive filter of the polarization-sensitive sensor arranged as a structural unit has a specific extension and orientation,
wherein the polarization filter has lattice structures produced by lithographic methods in at least one fabrication layer, and
wherein the polarization-sensitive sensors are arranged with different orientations, according to the proposal, of the polarization planes.

Reference may therefore be made to all the comments in relation to the proposed method for iteratively creating a matrix and the respective proposed arrangement.

According to a further teaching, which also has independent meaning, an integrated circuit for measuring the polarization of light is claimed
having at least two polarization-sensitive sensors with different orientation of the polarization planes,
wherein in the integrated circuit, devices are provided which are configured to make a statement about the polarization of the incident light from the signals of the polarization-sensitive sensors,
having at least one sensory element which is arranged to cooperate as a structural unit with a polarization filter for one of the polarization-sensitive sensors,
wherein the polarization-sensitive filter of the polarization-sensitive sensor arranged as a structural unit has a specific extension and orientation,
wherein the polarization filter has lattice structures produced by lithographic methods in at least one fabrication layer and/or wiring layer
wherein between the regions with lattice structures there are optically opaque walls present, which prevent interference from adjacent sensors under oblique incident light
wherein the optically opaque walls are produced by vias or contacts, and
wherein the polarization-sensitive sensors are arranged with different orientations, according to the proposal, of the polarization planes.

Reference may therefore be made to all the comments in relation to the proposed method for iteratively creating a matrix, the respective proposed arrangement and the proposed integrated circuit.

According to further teachings, which also have independent meaning, further integrated circuits for measuring the polarization of light are disclosed and claimed.

### BRIEF DESCRIPTION OF THE DRAWINGS

Hereafter the invention will be described in more detail by reference to a drawing showing only preferred exemplary embodiments:

FIG. 1: shows a rectangular 8×8 matrix of 4 base elements (FIG. 2 of EP2522960) with symmetry violation in the corners and non-congruent centers of gravity of the individual elements, due to being assembled by pure copying and shear operations on a 4×1 array, corresponding to a pure copy operation of an asymmetric 4×4 base matrix,

FIG. 2: shows an array according to the invention with 32×32 elements for a polarization sensor with 4 base elements each rotated by 45°. It can be seen that the array is based on a smaller base cell, which forms a superordinate pattern. The creation order of the expansion operators for creating this matrix is OP4-OP1-OP4-OP4,

FIG. 3: shows a detail with an 8×8 submatrix. The mirror symmetry in relation to the center is clearly visible, which ensures that the centers of gravity of the individual components fall at the same point,

FIG. 4: shows the matrix from FIG. 2 with numbered base elements for easier identification,

FIG. 5: shows a virtual exposure experiment to determine the quality of a matrix for a polarization sensor. The light source is displaced and tilted over the matrix and, for example, adjusted at a distance so that the desired error limit (e.g. 2:1 brightness difference) is just reached. The light intensities of the individual base elements are then determined and the intensities of identical elements are added together. An error size can be determined from the 4 values obtained. The displacement is expediently carried out in accordance with the Nyquist criterion, i.e. where possible in steps of half a basic cell or less, in order to be able to detect local maxima,

FIG. 6: shows the result of a virtual illumination experiment over the 32×32 matrix of FIGS. 2 and 3. It can be seen that when the light source is displaced, periodic errors occur, but these are relatively evenly distributed. Other matrices of the same order of magnitude are typically also good for a plurality of positions, but in some cases have larger errors,

FIG. 7: shows an example of filling a larger matrix with blocked zones in the corners, intended for filling with 2×2 matrices. In addition to the (trivial) retrospective deletion of elements of a square matrix, a permutation of all submatrices on the remaining areas can lead to a different and better solution,

FIG. 8: shows a selection of the best 16×16 matrices for 4 base elements and associated resolution (base 2 logarithm of the reciprocal of the error), FIG. 8a) 12.5487888882, FIG. 8b) 12.5922011498, FIG. 8c) 12.6634934402, FIG. 8d) 12.8591702292,

FIG. 9: shows a selection of the best 32×32 matrices for 4 base elements and associated resolution (base 2 logarithm of the reciprocal of the error). It can be seen that patterns with recognizably extended structures perform worse (in a and c e.g. extended diagonals are recognizable, in e (corresponding to FIG. 3) a more complex pattern with shorter sections is present), FIG. 9a) 15.2186402865, FIG. 9b) 15.3346640828, FIG. 9c) 15.4301443917, FIG. 9d) 15.520219736, FIG. 9e) 15.5323944499.

### DETAILED DESCRIPTION OF THE INVENTION

The exemplary embodiment shown in the figures, and in this regard preferred, relates to a method for iteratively generating a matrix of base elements, wherein base elements can be sensors or antennas with specific properties or different orientations, as well as electronic components with different circuitry.

Essential to this is
that a base matrix is first formed which contains at least all base elements once, but which can also contain empty elements, namely positions which are not occupied by one of the base elements,
that modification operators, such as rotation and reflection, are applied iteratively, which can transform the base matrix or any matrix arising therefrom into a modified matrix,
that expansion operators, which form a larger matrix from a plurality of optionally modified matrices from the preceding iteration by copying, rotation or reflection by virtue of parts of the larger matrix being filled with the optionally modified smaller matrices, are applied iteratively,
that virtual experiments are performed, within the scope of which the properties of a created matrix are examined by the systematic creation of values deliberately containing errors from which an error signal can be derived, and
that in order to create a complex matrix, all permutations of next larger matrices are first formed by applying expansion operators and evaluated by means of virtual experiments, the next larger matrices with the smallest error signals are subsequently selected, and larger matrices are then formed successively therefrom by applying expansion operators and then evaluated by means of virtual experiments until the error signal drops below a given limit.

The invention proposes an arrangement of a plurality of four different base elements (1,2,3,4) into an 8×8 matrix, wherein the base elements in the first row of the 8×8 matrix have the arrangement [1,2,3,4,2,1,4,3], those in the second row of the 8×8 matrix have the arrangement [4,3,2,1,3,4,1,2], those in the third row of the 8×8 matrix have the arrangement [3,4,1,2,4,3,2,1], those in the fourth row of the 8×8 matrix have the arrangement [2,1,4,3,1,2,3,4], those in the fifth row of the 8×8 matrix have the arrangement [4,3,2,1,3,4,1,2], those in the sixth row of the arrangement have the arrangement [1,2,3,4,2,1,4,3], those in the seventh row of the 8×8 matrix have the arrangement [2,1,4,3,1,2,3,4] and those in the eighth row of the 8×8 matrix have the arrangement [3,4,1,2,4,3,2,1].

Reference may therefore be made to all the comments in relation to the proposed method for iteratively creating a matrix.

An arrangement of a plurality of four different base elements (1,2,3,4) into a 16×16 matrix is proposed, wherein
a) the base elements in the first row of the 16×16 matrix have the arrangement [1,2,4,3,2,1,3,4, 1,2,4,3,2,1,3,4], those in the second row of the 16×16 matrix have the arrangement [4,3,2,1,3,4,1,2, 4,3,2,1,3,4,1,2], those in the third row of the 16×16 matrix have the arrangement [3,4,1,2,4,3,2,1, 3,4,1,2,4,3,2,1], those in the fourth row of the 16×16 matrix have the arrangement [2,1,3,4,1,2,4,3, 2,1,3,4,1,2,4,3], those in the fifth row of the 16×16 matrix have the arrangement [3,4,2,1,4,3,1,2, 3,4,2,1,4,3,1,2], those in the sixth row of the 16×16 matrix have the arrangement [1,2,3,4,2,1,4,3, 1,2,3,4,2,1,4,3], those in the seventh row of the 16×16 matrix have the arrangement [2,1,4,3,1,2,3,4, 2,1,4,3,1,2,3,4], those in the eighth row of the 16×16 matrix have the arrangement [4,3,1,2,3,4,2,1, 4,3,1,2,3,4,2,1], those in the ninth row of the 16×16 matrix have the arrangement [1,2,4,3,2,1,3,4, 1,2,4,3,2,1,3,4], those in the tenth row of the 16×16 matrix have the arrangement [4,3,2,1,3,4,1,2, 4,3,2,1,3,4,1,2], those in the eleventh row of the 16×16 matrix have the arrangement [3,4,1,2,4,3,2,1, 3,4,1,2,4,3,2,1], those in the twelfth row of the 16×16 matrix have the arrangement [2,1,3,4,1,2,4,3, 2,1,3,4,1,2,4,3], those in the thirteenth row of the 16×16 matrix have the arrangement [3,4,2,1,4,3,1,2, 3,4,2,1,4,3,1,2], those in the fourteenth row of the 16×16 matrix have the arrangement [1,2,3,4,2,1,4,3, 1,2,3,4,2,1,4,3], those in the fifteenth row of the 16×16 matrix have the arrangement [2,1,4,3,1,2,3,4, 2,1,4,3,1,2,3,4], those in the sixteenth row of the 16×16 matrix have the arrangement [4,3,1,2,3,4,2,1, 4,3,1,2,3,4,2,1], or
b) the base elements in the first row of the 16×16 matrix have the arrangement [1,2,3,4,2,3,4,1, 1,4,3,2,4,3,2,1], those in the second row of the 16×16 matrix have the arrangement [4,3,2,1,1,4,3,2, 2,3,4,1,1,2,3,4], those in the third row of the 16×16 matrix have the arrangement [3,4,1,2,4,1,2,3, 3,2,1,4,2,1,4,3], those in the fourth row of the 16×16 matrix have the arrangement [2,1,4,3,3,2,1,4, 4,1,2,3,3,4,1,2], those in the fifth row of the 16×16 matrix have the arrangement [4,1,2,3,3,4,1,2, 2,1,4,3,3,2,1,4], those in the sixth row of the 16×16 matrix have the arrangement [3,2,1,4,2,1,4,3, 3,4,1,2,4,1,2,3], those in the seventh row of the 16×16 matrix have the arrangement [2,3,4,1,1,2,3,4, 4,3,2,1,1,4,3,2], those in the eighth row of the 16×16 matrix have the arrangement [1,4,3,2,4,3,2,1, 1,2,3,4,2,3,4,1], those in the ninth row of the 16×16 matrix have the arrangement [1,4,3,2,4,3,2,1, 1,2,3,4,2,3,4,1], those in the tenth row of the 16×16 matrix have the arrangement [2,3,4,1,1,2,3,4, 4,3,2,1,1,4,3,2], those in the eleventh row of the 16×16 matrix have the arrangement [3,2,1,4,2,1,4,3, 3,4,1,2,4,1,2,3], those in the twelfth row of the 16×16 matrix have the arrangement [4,1,2,3,3,4,1,2, 2,1,4,3,3,2,1,4], those in the thirteenth row of the 16×16 matrix have the arrangement [2,1,4,3,3,2,1,4, 4,1,2,3,3,4,1,2], those in the fourteenth row of the 16×16 matrix have the arrangement [3,4,1,2,4,1,2,3, 3,2,1,4,2,1,4,3], those in the fifteenth row of the 16×16 matrix have the arrangement [4,3,2,1,1,4,3,2, 2,3,4,1,1,2,3,4], those in the sixteenth row of the 16×16 matrix have the arrangement [1,2,3,4,2,3,4,1, 1,4,3,2,4,3,2,1], or
c) the base elements in the first row of the 16×16 matrix have the arrangement [1,2,3,4,1,2,3,4, 1,2,3,4,1,2,3,4], those in the second row of the 16×16 matrix have the arrangement [4,3,2,1,4,3,2,1, 4,3,2,1,4,3,2,1], those in the third row of the 16×16 matrix have the arrangement [3,4,1,2,3,4,1,2, 3,4,1,2,3,4,1,2], those in the fourth row of the 16×16 matrix have the arrangement [2,1,4,3,2,1,4,3, 2,1,4,3,2,1,4,3], those in the fifth row of the 16×16 matrix have the arrangement [1,2,3,4,1,2,3,4, 1,2,3,4,1,2,3,4], those in the sixth row of the 16×16 matrix have the arrangement [4,3,2,1,4,3,2,1, 4,3,2,1,4,3,2,1], those in the seventh row of the 16×16 matrix have the arrangement [3,4,1,2,3,4,1,2, 3,4,1,2,3,4,1,2], those in the eighth row of the 16×16 matrix have the arrangement [2,1,4,3,2,1,4,3, 2,1,4,3,2,1,4,3], those in the ninth row of the 16×16 matrix have the arrangement [1,2,3,4,1,2,3,4, 1,2,3,4,1,2,3, 4], those in the tenth row of the 16×16 matrix have the arrangement [4,3,2,1,4,3,2,1, 4,3,2,1,4,3,2,1], those in the eleventh row of the 16×16 matrix have the arrangement [3,4,1,2,3,4,1,2, 3,4,1,2,3,4,1,2], those in the twelfth row of the 16×16 matrix have the arrangement [2,1,4,3,2,1,4,3, 2,1,4,3,2,1,4,3], those in the thirteenth row of the 16×16 matrix have the arrangement [1,2,3,4,1,2,3,4, 1,2,3,4,1,2,3,4], those in the fourteenth row of the 16×16 matrix have the arrangement [4,3,2,1,4,3,2,1, 4,3,2,1,4,3,2,1], those in the fifteenth row of the 16×16 matrix have the arrangement [3,4,1,2,3,4,1,2, 3,4,1,2,3,4,1,2], those in the sixteenth row of the 16×16 matrix have the arrangement [2,1,4,3,2,1,4,3, 2,1,4,3,2,1,4,3], or
d) the base elements in the first row of the 16×16 matrix have the arrangement [1,2,3,4,2,1,4,3, 1,2,3,4,2,1,4, 3], those in the second row of the 16×16 matrix have the arrangement [4,3,2,1,3,4,1,2, 4,3,2,1,3,4,1,2], those in the third row of the 16×16 matrix have the arrangement [3,4,1,2,4,3,2,1, 3,4,1,2,4,3,2,1], those in the fourth row of the 16×16 matrix have the arrangement [2,1,4,3,1,2,3,4, 2,1,4,3,1,2,3,4], those in the fifth row of the 16×16 matrix have the arrangement [4,3,2,1,3,4,1,2, 4,3,2,1,3,4,1,2], those in the sixth row of the 16×16 matrix have the arrangement [1,2,3,4,2,1,4,3, 1,2,3,4,2,1,4,3], those in the seventh row of the 16×16 matrix have the arrangement [2,1,4,3,1,2,3,4, 2,1,4,3,1,2,3,4], those in the eighth row of the 16×16 matrix have the arrangement [3,4,1,2,4,3,2,1, 3,4,1,2,4,3,2,1], those in the ninth row of the 16×16 matrix have the arrangement [1,2,3,4,2,1,4,3, 1,2,3,4,2,1,4,3], those in the tenth row of the 16×16 matrix have the arrangement [4,3,2,1,3,4,1,2, 4,3,2,1,3,4,1,2], those in the eleventh row of the 16×16 matrix have the arrangement [3,4,1,2,4,3,2,1, 3,4,1,2,4,3,2,1], those in the twelfth row of the 16×16 matrix have the arrangement [2,1,4,3,1,2,3,4, 2,1,4,3,1,2,3,4], those in the thirteenth row of the 16×16 matrix have the arrangement [4,3,2,1,3,4,1,2, 4,3,2,1,3,4,1,2], those in the fourteenth row of the 16×16 matrix have the arrangement [1,2,3,4,2,1,4,3, 1,2,3,4,2,1,4,3], those in the fifteenth row of the 16×16 matrix have the arrangement [2,1,4,3,1,2,3,4, 2,1,4,3,1,2,3,4], those in the sixteenth row of the 16×16 matrix have the arrangement [3,4,1,2,4,3,2,1, 3,4,1,2,4,3,2,1].

Reference may therefore be made to all the comments in relation to the proposed method for iteratively creating a matrix and the proposed arrangement.

An arrangement of a plurality of four different base elements (1,2,3,4) into a 32×32 matrix is proposed, wherein
a) the base elements in the first row have the arrangement [12341234 23412341 12341234 23412341], those in the second row of the 32×32 matrix have the arrangement [43214321 14321432 43214321 14321432], those in the third row of the 32×32 matrix have the arrangement [34123412 41234123 34123412 41234123], those in the fourth row of the 32×32 matrix have the arrangement [21432143 32143214 21432143 32143214], those in the fifth row of the 32×32 matrix have the arrangement [12341234 23412341 12341234 23412341], those in the sixth row of the 32×32 matrix have the arrangement [43214321 14321432 43214321 14321432], those in the seventh row of the 32×32 matrix have the arrangement [34123412 41234123 34123412 41234123], those in the eighth row of the 32×32 matrix have the arrangement [21432143 32143214 21432143 32143214], those in the ninth row of the 32×32 matrix have the arrangement [41234123 34123412 41234123 34123412], those in the tenth row of the 32×32 matrix have the arrangement [32143214 21432143 32143214 21432143], those in the eleventh row of the 32×32 matrix have the arrangement [23412341 12341234 23412341 12341234], those in the twelfth row of the 32×32 matrix have the arrangement [14321432 43214321 14321432 43214321], those in the 13th row of the 32×32 matrix have the arrangement [41234123 34123412 41234123 34123412], those in the 14th row of the 32×32 matrix have the arrangement [32143214 21432143 32143214 21432143], those in the 15th row of the 32×32 matrix have the arrangement [23412341 12341234 23412341 12341234], those in the 16th row of the 32×32 matrix have the arrangement [14321432 43214321 14321432 43214321], those in the 17th row of the 32×32 matrix have the arrangement [12341234 23412341 12341234 23412341], those in the 18th row of the 32×32 matrix have the arrangement [43214321 14321432 43214321 14321432], those in the 19th row of the 32×32 matrix have the arrangement [34123412 41234123 34123412 41234123], those in the 20th row of the 32×32 matrix have the arrangement [21432143 32143214 21432143 32143214], those in the 21st row of the 32×32 matrix have the arrangement [12341234 23412341 12341234 23412341], those in the 22nd row of the 32×32 matrix have the arrangement [43214321 14321432 43214321 14321432], those in the 23rd row of the 32×32 matrix have the arrangement [34123412 41234123 34123412 41234123], those in the 24th row of the 32×32 matrix have the arrangement [21432143 32143214 21432143 32143214], those in the 25th row of the 32×32 matrix have the arrangement [41234123 34123412 41234123 34123412], those in the 26th row of the 32×32 matrix have the arrangement [32143214 21432143 32143214 21432143], those in the 27th row of the 32×32 matrix have the arrangement [23412341 12341234 23412341 12341234], those in the 28th row of the 32×32 matrix have the arrangement [14321432 43214321 14321432 43214321], those in the 29th row of the 32×32 matrix have the arrangement [41234123 34123412 41234123 34123412], those in the 30th row of the 32×32 matrix have the arrangement [32143214 21432143 32143214 21432143], those in the 31st row of the 32×32 matrix have the arrangement [23412341 12341234 23412341 12341234], those in the 32nd row of the 32×32 matrix have the arrangement [14321432 43214321 14321432 43214321], or
b) the base elements in the first row of the 32×32 matrix have the arrangement [12342341 14324321 12342341 14324321], those in the second row of the 32×32 matrix have the arrangement [43211432 23411234 43211432 23411234], those in the third row of the 32×32 matrix have the arrangement [34123412 41234123 34123412 41234123], those in the fourth row of the 32×32 matrix have the arrangement [21433214 41233412 21433214 41233412], those in the fifth row of the 32×32 matrix have the arrangement [41233412 21433214 41233412 21433214], those in the sixth row of the 32×32 matrix have the arrangement [32142143 34124123 32142143 34124123], those in the seventh row of the 32×32 matrix have the arrangement [23411234 43211432 23411234 43211432], those in the eighth row of the 32×32 matrix have the arrangement [14324321 12342341 14324321 12342341], those in the ninth row of the 32×32 matrix have the arrangement [14324321 12342341 14324321 12342341], those in the tenth row of the 32×32 matrix have the arrangement [23411234 43211432 23411234 43211432], those in the eleventh row of the 32×32 matrix have the arrangement [32142143 34124123 32142143 34124123], those in the twelfth row of the 32×32 matrix have the arrangement [41233412 21433214 41233412 21433214], those in the 13th row of the 32×32 matrix have the arrangement [21433214 41233412 21433214 41233412], those in the 14th row of the 32×32 matrix have the arrangement [34124123 32142143 34124123 32142143], those in the 15th row of the 32×32 matrix have the arrangement [43211432 23411234 43211432 23411234], those in the 16th row of the 32×32 matrix have the arrangement [12342341 14324321 12342341 14324321], those in the 17th row of the 32×32 matrix have the arrangement [12342341 14324321 12342341 14324321], those in the 18th row of the 32×32 matrix have the arrangement [43211432 23411234 43211432 23411234], those in the 19th row of the 32×32 matrix have the arrangement [34124123 32142143 34124123 32142143], those in the 20th row of the 32×32 matrix have the arrangement [21433214 41233412 21433214 41233412], those in the 21st row of the 32×32 matrix have the arrangement [41233412 21433214 41233412 21433214], those in the 22nd row of the 32×32 matrix have the arrangement [32142143 34124123 32142143 34124123], those in the 23rd row of the 32×32 matrix have the arrangement [23411234 43211432 23411234 43211432], those in the 24th row of the 32×32 matrix have the arrangement [14324321 12342341 14324321 12342341], those in the 25th row of the 32×32 matrix have the arrangement [14324321 12342341 14324321 12342341], those in the 26th row of the 32×32 matrix have the arrangement [23411234 43211432 23411234 43211432], those in the 27th row of the 32×32 matrix have the arrangement [32142143 34124123 32142143 34124123], those in the 28th row of the 32×32 matrix have the arrangement [41233412 21433214 41233412 21433214], those in the 29th row of the 32×32 matrix have the arrangement [21433214 41233412 21433214 41233412], those in the 30th row of the 32×32 matrix have the arrangement [34124123 32142143 34124123 32142143], those in the 31st row of the 32×32 matrix have the arrangement [43211432 23411234 43211432 23411234], those in the 32nd row of the 32×32 matrix have the arrangement [12342341 14324321 12342341 14324321], or
c) the base elements in the first row of the 32×32 matrix have the arrangement [12341234 21432143 12341234 21432143], those in the second row of the 32×32 matrix have the arrangement [43214321 34123412 43214321 34123412], those in the third row of the 32×32 matrix have the arrangement [34123412 43214321 34123412 43214321], those in the fourth row of the 32×32 matrix have the arrangement [21432143 12341234 21432143 12341234], those in the fifth row of the 32×32 matrix have the arrangement [12341234 21432143 12341234 21432143], those in the sixth row of the 32×32 matrix have the arrangement [43214321 34123412 43214321 34123412], those in the seventh row of the 32×32 matrix have the arrangement [34123412 43214321 34123412 43214321], those in the eighth row of the 32×32 matrix have the arrangement [21432143 12341234 21432143 12341234], those in the ninth row of the 32×32 matrix have the arrangement [43214321 34123412 43214321 34123412], those in the tenth row of the 32×32 matrix have the arrangement [12341234 21432143 12341234 21432143], those in the eleventh row of the 32×32 matrix have the arrangement [21432143 12341234 21432143 12341234], those in the twelfth row of the 32×32 matrix have the arrangement [34123412 43214321 34123412 43214321], those in the 13th row of the 32×32 matrix have the arrangement [43214321 34123412 43214321 34123412], those in the 14th row of the 32×32 matrix have the arrangement [12341234 21432143 12341234 21432143], those in the 15th row of the 32×32 matrix have the arrangement [21432143 12341234 21432143 12341234], those in the 16th row of the 32×32 matrix have the arrangement [34123412 43214321 34123412 43214321], those in the 17th row of the 32×32 matrix have the arrangement [12341234 21432143 12341234 21432143], those in the 18th row of the 32×32 matrix have the arrangement [43214321 34123412 43214321 34123412], those in the 19th row of the 32×32 matrix have the arrangement [34123412 43214321 34123412 43214321], those in the 20th row of the 32×32 matrix have the arrangement [21432143 12341234 21432143 12341234], those in the 21st row of the 32×32 matrix have the arrangement [12341234 21432143 12341234 21432143], those in the 22nd row of the 32×32 matrix have the arrangement [43214321 34123412 43214321 34123412], those in the 23rd row of the 32×32 matrix have the arrangement [34123412 43214321 34123412 43214321], those in the 24th row of the 32×32 matrix have the arrangement [21432143 12341234 21432143 12341234], those in the 25th row of the 32×32 matrix have the arrangement [43214321 34123412 43214321 34123412], those in the 26th row of the 32×32 matrix have the arrangement [12341234 21432143 12341234 21432143], those in the 27th row of the 32×32 matrix have the arrangement [21432143 12341234 21432143 12341234], those in the 28th row of the 32×32 matrix have the arrangement [34123412 43214321 34123412 43214321], those in the 29th row of the 32×32 matrix have the arrangement [43214321 34123412 43214321 34123412], those in the 30th row of the 32×32 matrix have the arrangement [12341234 21432143 12341234 21432143], those in the 31st row of the 32×32 matrix have the arrangement [21432143 12341234 21432143 12341234], those in the 32nd row of the 32×32 matrix have the arrangement [34123412 43214321 34123412 43214321], or
d) the base elements in the first row of the 32×32 matrix have the arrangement [12342341 12342341 12342341 12342341], those in the second row of the 32×32 matrix have the arrangement [43211432 43211432 43211432 43211432], those in the third row of the 32×32 matrix have the arrangement [34124123 34124123 34124123 34124123], those in the fourth row of the 32×32 matrix have the arrangement [21433214 21433214 21433214 21433214], those in the fifth row of the 32×32 matrix have the arrangement [41233412 41233412 41233412 41233412], those in the sixth row of the 32×32 matrix have the arrangement [32142143 32142143 32142143 32142143], those in the seventh row of the 32×32 matrix have the arrangement [23411234 23411234 23411234 23411234], those in the eighth row of the 32×32 matrix have the arrangement [14324321 14324321 14324321 14324321], those in the ninth row of the 32×32 matrix have the arrangement [12342341 12342341 12342341 12342341], those in the tenth row of the 32×32 matrix have the arrangement [43211432 43211432 43211432 43211432], those in the eleventh row of the 32×32 matrix have the arrangement [34124123 34124123 34124123 34124123], those in the twelfth row of the 32×32 matrix have the arrangement [21433214 21433214 21433214 21433214], those in the 13th row of the 32×32 matrix have the arrangement [41233412 41233412 41233412 41233412], those in the 14th row of the 32×32 matrix have the arrangement [32142143 32142143 32142143 32142143], those in the 15th row of the 32×32 matrix have the arrangement [23411234 23411234 23411234 23411234], those in the 16th row of the 32×32 matrix have the arrangement [14324321 14324321 14324321 14324321], those in the 17th row of the 32×32 matrix have the arrangement [12342341 12342341 12342341 12342341], those in the 18th row of the 32×32 matrix have the arrangement [43211432 43211432 43211432 43211432], those in the 19th row of the 32×32 matrix have the arrangement [34124123 34124123 34124123 34124123], those in the 20th row of the 32×32 matrix have the arrangement [21433214 21433214 21433214 21433214], those in the 21st row of the 32×32 matrix have the arrangement [41233412 41233412 41233412 41233412], those in the 22nd row of the 32×32 matrix have the arrangement [32142143 32142143 32142143 32142143], those in the 23rd row of the 32×32 matrix have the arrangement [23411234 23411234 23411234 23411234], those in the 24th row of the 32×32 matrix have the arrangement [14324321 14324321 14324321 14324321], those in the 25th row of the 32×32 matrix have the arrangement [12342341 12342341 12342341 12342341], those in the 26th row of the 32×32 matrix have the arrangement [43211432 43211432 43211432 43211432], those in the 27th row of the 32×32 matrix have the arrangement [34124123 34124123 34124123 34124123], those in the 28th row of the 32×32 matrix have the arrangement [21433214 21433214 21433214 21433214], those in the 29th row of the 32×32 matrix have the arrangement [41233412 41233412 41233412 41233412], those in the 30th row of the 32×32 matrix have the arrangement [32142143 32142143 32142143 32142143], those in the 31st row of the 32×32 matrix have the arrangement [23411234 23411234 23411234 23411234], those in the 32nd row of the 32×32 matrix have the arrangement [14324321 14324321 14324321 14324321], or
e) the base elements in the first row of the 32×32 matrix have the arrangement [12342143 12342143 12342143 12342143], those in the second row of the 32×32 matrix have the arrangement [43213412 43213412 43213412 43213412], those in the third row of the 32×32 matrix have the arrangement [34124321 34124321 34124321 34124321], those in the fourth row of the 32×32 matrix have the arrangement [21431234 21431234 21431234 21431234], those in the fifth row of the 32×32 matrix have the arrangement [43213412 43213412 43213412 43213412], those in the sixth row of the 32×32 matrix have the arrangement [12342143 12342143 12342143 12342143], those in the seventh row of the 32×32 matrix have the arrangement [21431234 21431234 21431234 21431234], those in the eighth row of the 32×32 matrix have the arrangement [34124321 34124321 34124321 34124321], those in the ninth row of the 32×32 matrix have the arrangement [12342143 12342143 12342143 12342143], those in the tenth row of the 32×32 matrix have the arrangement [43213412 43213412 43213412 43213412], those in the eleventh row of the 32×32 matrix have the arrangement [34124321 34124321 34124321 34124321], those in the twelfth row of the 32×32 matrix have the arrangement [21431234 21431234 21431234 21431234], those in the 13th row of the 32×32 matrix have the arrangement [43213412 43213412 43213412 43213412], those in the 14th row of the 32×32 matrix have the arrangement [12342143 12342143 12342143 12342143], those in the 15th row of the 32×32 matrix have the arrangement [21431234 21431234 21431234 21431234], those in the 16th row of the 32×32 matrix have the arrangement [34124321 34124321 34124321 34124321], those in the 17th row of the 32×32 matrix have the arrangement [12342143 12342143 12342143 12342143], those in the 18th row of the 32×32 matrix have the arrangement [43213412 43213412 43213412 43213412], those in the 19th row of the 32×32 matrix have the arrangement [34124321 34124321 34124321 34124321], those in the 20th row of the 32×32 matrix have the arrangement [21431234 21431234 21431234 21431234], those in the 21st row of the 32×32 matrix have the arrangement [43213412 43213412 43213412 43213412], those in the 22nd row of the 32×32 matrix have the arrangement [12342143 12342143 12342143 12342143], those in the 23rd row of the 32×32 matrix have the arrangement [21431234 21431234 21431234 21431234], those in the 24th row of the 32×32 matrix have the arrangement [34124321 34124321 34124321 34124321], those in the 25th row of the 32×32 matrix have the arrangement [12342143 12342143 12342143 12342143], those in the 26th row of the 32×32 matrix have the arrangement [43213412 43213412 43213412 43213412], those in the 27th row of the 32×32 matrix have the arrangement [34124321 34124321 34124321 34124321], those in the 28th row of the 32×32 matrix have the arrangement [21431234 21431234 21431234 21431234], those in the 29th row of the 32×32 matrix have the arrangement [43213412 43213412 43213412 43213412], those in the 30th row of the 32×32 matrix have the arrangement [12342143 12342143 12342143 12342143], those in the 31st row of the 32×32 matrix have the arrangement [21431234 21431234 21431234 21431234], those in the 32nd row of the 32×32 matrix have the arrangement [34124321 34124321 34124321 34124321].

Reference may therefore be made to all the comments in relation to the proposed method for iteratively creating a matrix and the respective proposed arrangement.

Furthermore it is preferably provided that a larger array is created from the smaller arrays by means of copying, rotation or reflection operations.

It is further preferably provided here that individual positions of the matrix-like arrangement remain unoccupied.

An integrated circuit for measuring the polarization of light is proposed
having polarization-sensitive sensors with at least two different orientations of the polarization planes,
wherein in the integrated circuit, devices are provided which are configured to make a statement about the polarization of the incident light from the signals of the polarization-sensitive sensors,
having at least one sensory element which is arranged to cooperate as a structural unit with a polarization filter for one of the polarization-sensitive sensors,
wherein the polarization-sensitive filter of the polarization-sensitive sensor arranged as a structural unit has a specific extension and orientation,
wherein the polarization filter has lattice structures produced by lithographic methods in at least one fabrication layer, and
wherein the polarization-sensitive sensors are arranged with different orientations of the polarization planes as disclosed and claimed herein.

Reference may therefore be made to all the comments in relation to the proposed method for iteratively creating a matrix and the respective proposed arrangement.

An integrated circuit for measuring the polarization of light is proposed
having at least two polarization-sensitive sensors with different orientation of the polarization planes,
wherein in the integrated circuit, devices are provided which are configured to make a statement about the polarization of the incident light from the signals of the polarization-sensitive sensors,
having at least one sensory element which is arranged to cooperate as a structural unit with a polarization filter for one of the polarization-sensitive sensors,
wherein the polarization-sensitive filter of the polarization-sensitive sensor arranged as a structural unit has a specific extension and orientation,
wherein the polarization filter has lattice structures produced by lithographic methods in at least one fabrication layer and/or wiring layer
wherein between the regions with lattice structures there are optically opaque walls present, which prevent interference from adjacent sensors under oblique incident light
wherein the optically opaque walls are produced by vias or contacts, and
wherein the polarization-sensitive sensors are arranged with different orientations of the polarization planes as disclosed and claimed herein.

Reference may therefore be made to all the comments in relation to the proposed method for iteratively creating a matrix, the respective proposed arrangement and the proposed integrated circuit.

The following comments can be applied to arrangements with different numbers of base elements that differ from each other, for example systems with 2 base elements (differential sensor or transistors of a differential amplifier), or even more than 4 base elements. While the patterns created in this way differ, the method of creating them remains the same. The following text analyzes examples of arrangements of 4 different base elements, which are interesting for many applications. In addition to polarization measurement with 4 quadrants for generating a differential quadrature signal, comparable arrangements with magnetoresistive sensors are conceivable. Color sensors with e.g. a Bayer matrix are also included in this scheme.

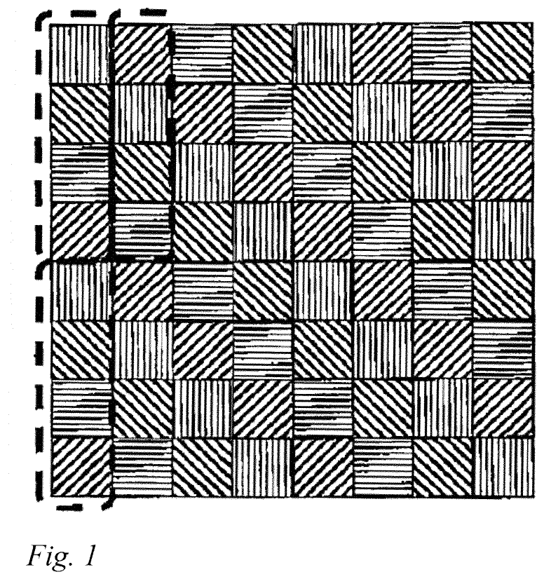

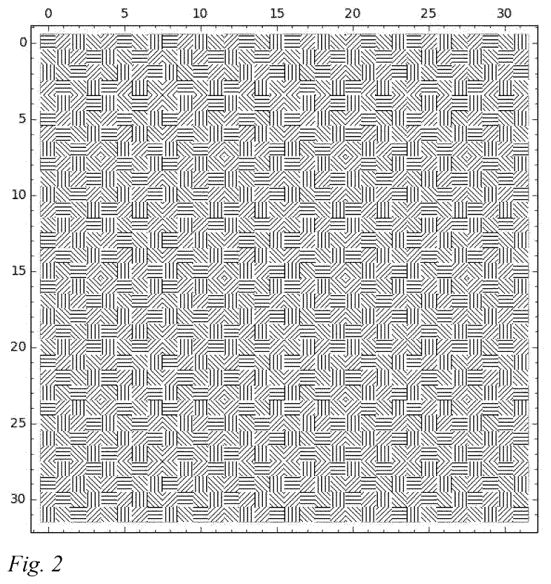

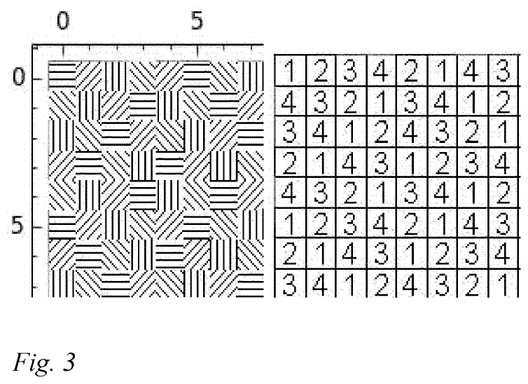

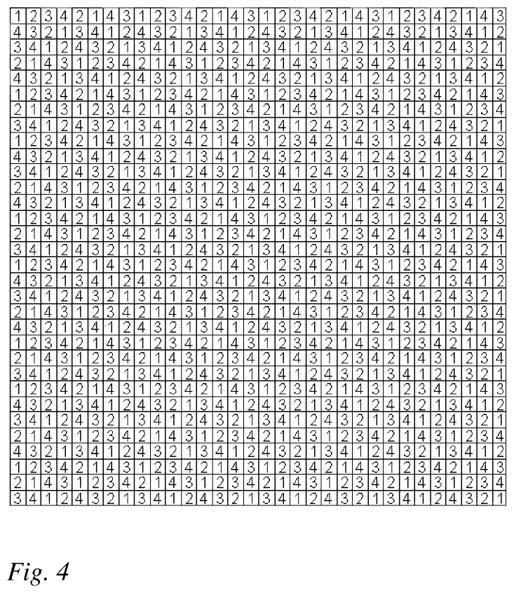

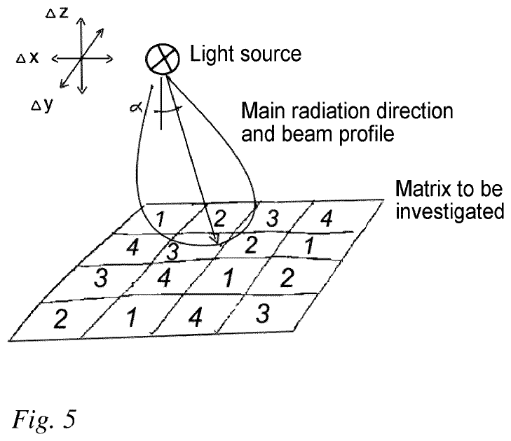

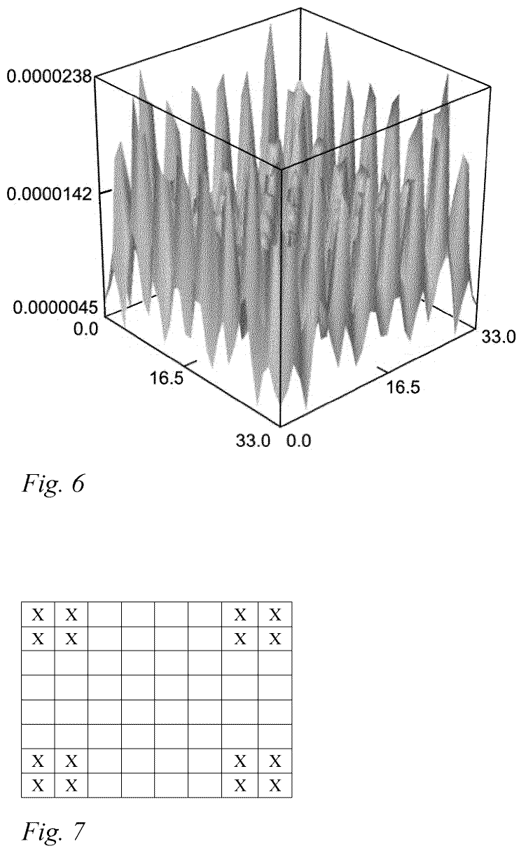

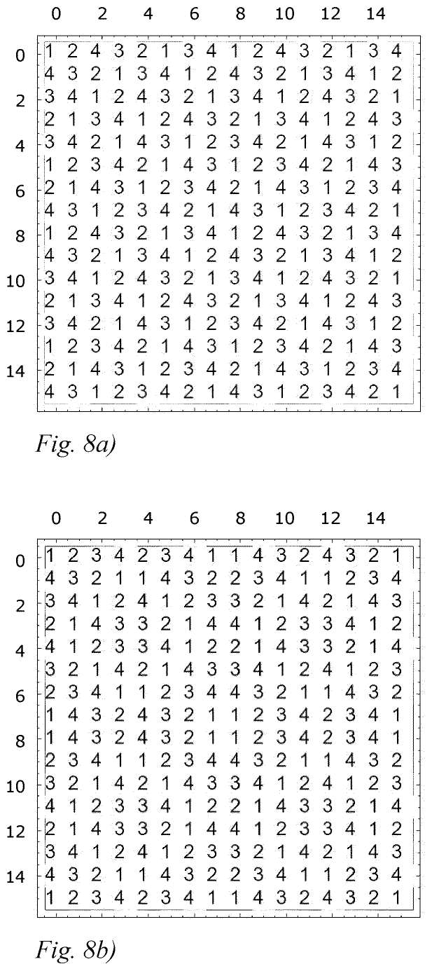

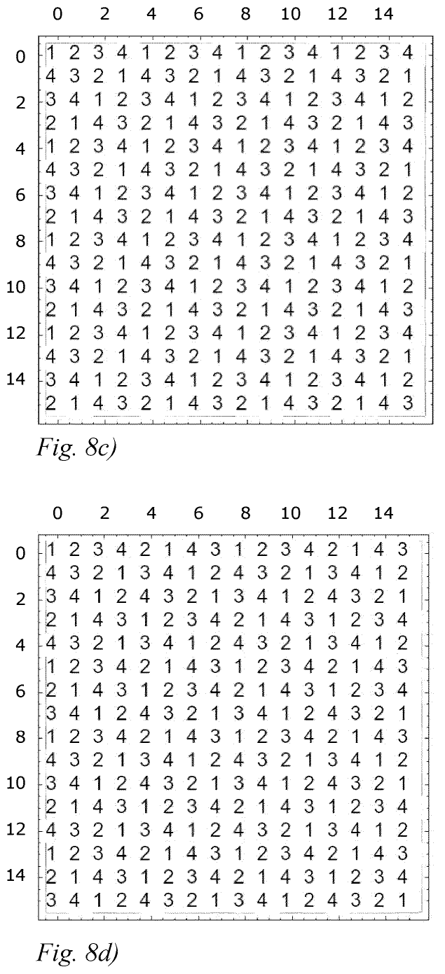

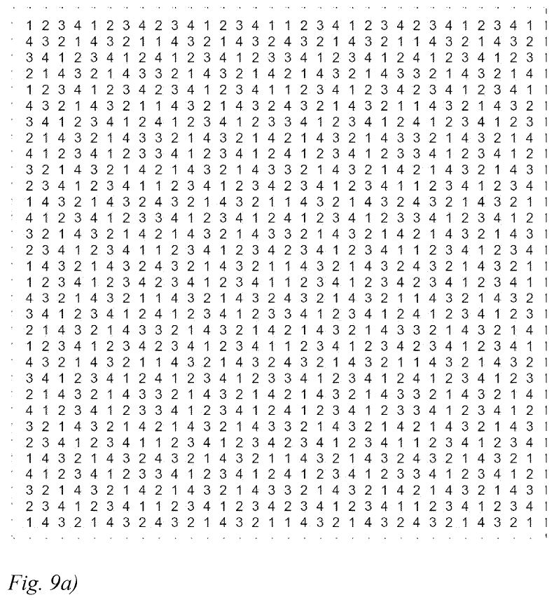

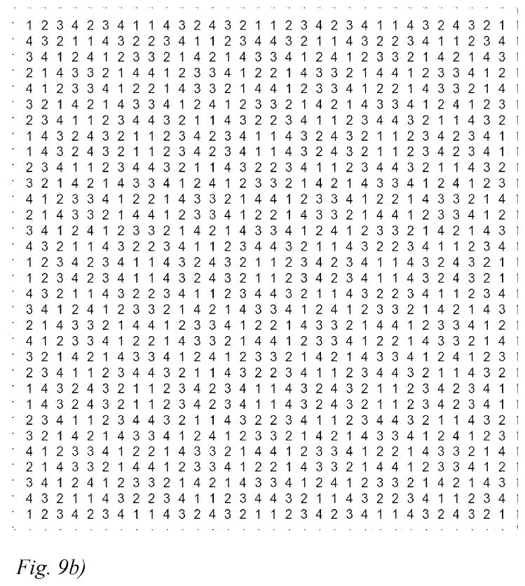

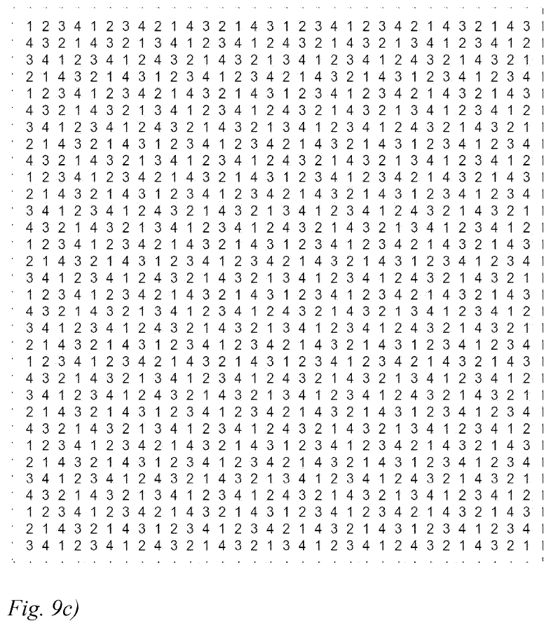

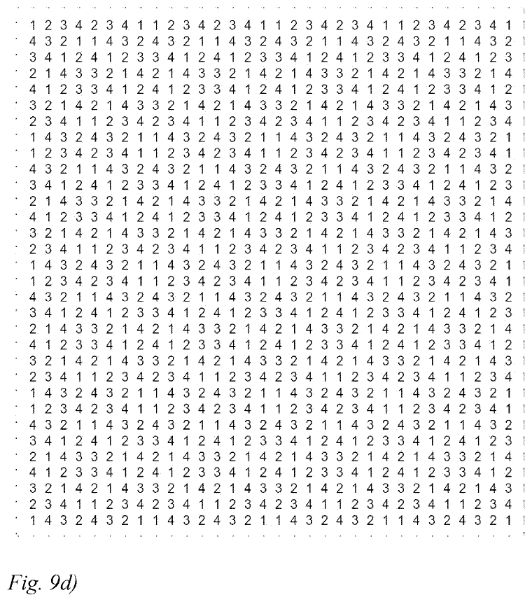

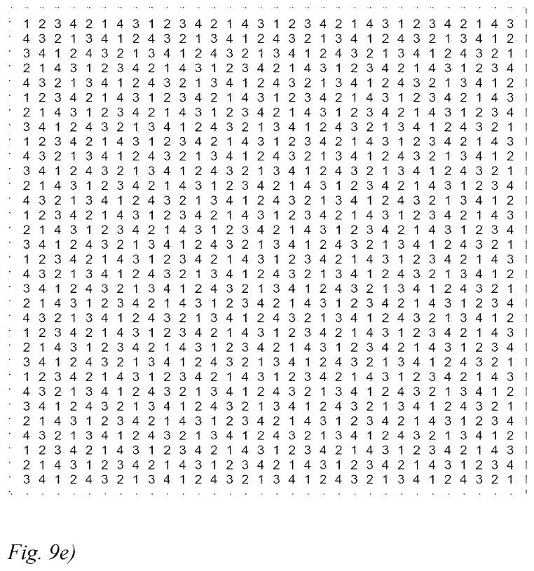

4 base elements or individual sensors can be arranged linearly or in a 2×2 matrix. In order to minimize the effects of gradients, a maximally compact arrangement is advantageous, so that the 2×2 arrangement (base matrix) is preferred. A larger arrangement of these base elements can now easily be generated by repeated arrangement of the same base matrix (see FIG. 1, which corresponds to FIG. 2 in EP 2522960 A1). This already has better properties than, for example, a single base matrix with a larger overall surface area, but exhibits systematic errors. In particular, the positional center of gravity of the individual base elements is different from each other, so that in the case of uneven illumination of an optical sensor a residual error remains. In FIG. 1, this is easily seen in the corners, since the elements at the top left and bottom right are identical, while different elements are placed at the top right and bottom left.

Even linear shifts in fragments of the base matrix do not solve this problem, since this is ultimately only a superposition or shearing of this regular matrix with similar errors. This is also clearly visible in FIG. 1, because the marked 4×1 base matrix was assembled into an 8×8-matrix using a 4-row identical copy and column-wise copy with ¼ shift. The resulting matrix has different properties along its two diagonals.

An arrangement is therefore required which reduces these systematic errors. To this end, it is obvious that the largest possible number of base elements is advantageous. This immediately creates a problem with an extremely large number of possible solutions. If we assume 4 base elements, which are arranged into a matrix with 32×32=1024 elements, this number is already 4¹⁰²⁴ Of course, most of these possible arrangements are inappropriate. Thus, for creating a differential quadrature signal, it is obvious that all 4 base elements must occur equally frequently. Also unsuitable are solutions in which one of the base elements is located predominantly in a corner of the array. However, as already stated the simple periodic arrangement of the base elements also has disadvantages, such as the lack of mirror symmetry, rotational symmetry and in particular, different centers of gravity of the base elements. Optimizing such an array is therefore a complex problem, and solutions to it with finite resources require a systematic approach and accurate investigation of the properties of all candidates found.

To do this, a base matrix is first created that contains all N base elements. Starting from this base matrix, successively more complex arrangements are created and optimal candidates are selected from them until a sufficient decomposition with sufficient accuracy is achieved against a predetermined test scenario.

In the case of a Gaussian brightness distribution which does not exceed a difference of factor 2 between maximum and minimum over the entire surface, but which can otherwise occupy any position across the sensor, for an arrangement of 4 base elements this means that an accuracy of a good 12 bits can be achieved with an arrangement of at least 16×16 base elements, while for just under 16 bits an arrangement of at least 32×32 base elements is required.

The simplest arrangement of four individual sensors giving two differential signal pairs is a 2×2 matrix, wherein the sensor pairs (1,3) and (2,4) each forming a differential pair are arranged as far as possible in such a way that they have a common center of gravity. In this case, radially symmetric illumination aligned with this center of gravity will not cause brightness related errors. The arrangement can therefore be described as

$$( \begin{matrix}1 & 2 \\ 4 & 3\end{matrix} ) ,$$

where all rotations and reflections of this matrix are equivalent.

A linear arrangement of these base elements, which also has a common center of gravity, is (1 2 4 3) or (2 1 3 4), where here also rotation and reflection are irrelevant. However, the 2×2 matrix arrangement is superior to the linear arrangement because typical signal sources or light sources are most likely able to be described as a point source. With a radial drop in signal intensity typical of point sources, the outer sensor pair is at a disadvantage in a linear arrangement. This disadvantage is eliminated with the 2×2 matrix arrangement. Larger base cells with empty cells or multiple individual elements of the same type can also be used, but in the case described here there are no advantages to be gained from this.

These simple arrangements (base matrices) have the disadvantage they are not able to compensate even linear gradients. To implement a differential amplifier with transistors A and B, the person skilled in the art will use either arrangements (A B B A) or

$$( \begin{matrix}A & B \\ B & A\end{matrix} )$$

in which the transistors are decomposed into smaller parts and arranged in such a way tilt one element is affected more strongly and one is affected more weakly. Assuming that the effect of parallel-connected elements can be described by a linear operation (sum signal), linear gradients are effectively compensated. However, here we want to achieve this with, for example, 4 base elements. The principle of matching differential pairs is therefore not quite so simple to transfer. In particular, copying the above-mentioned 2×2 base matrix or unit cell

$$EZ = ( \begin{matrix}1 & 2 \\ 4 & 3\end{matrix} )$$

to form a 4×4 matrix is not advisable, as this would remove the common center of gravity. Therefore, a reflection or rotation of some base matrices should also be carried out in order to obtain the common center of gravity, otherwise the tolerance to radially symmetric intensity profiles would be disturbed.

From this explanation it is already clear that a further enlargement of the matrix, in particular in binary steps (doubling the number of elements in each dimension) from the smaller units previously formed, leads to good results, since in this way the existing tolerance against certain effects can be relatively easily maintained and extended to further advantages, since already existing symmetries are supplemented by additional, more complex symmetries on different scales.

The repetition of sub-matrices formed in this way at different points of a total matrix also contributes to the fact that the total matrix becomes less sensitive to signal maxima at different points of the matrix, since for each submatrix a point already exists that is insensitive to radially symmetric errors. All base elements should be represented equally in edge regions to compensate for linear gradients. For a certain number of base elements, a kind of ideal base matrix with maximum symmetry results, from which larger matrices can also be created by copying. In the case of the 4 base elements that form two differential pairs, an 8×8 matrix is such a basic arrangement. There may be different such basic arrangements that have very similar properties.

If special requirements are placed on the form of the total matrix, individual positions of the total matrix can be marked as blocked, i.e. they remain unoccupied or the areas left free are used differently. In this way, for example, a light source can be positioned in a free zone in the center of an optical sensor (e.g. LED-on-chip), so that the light source lies exactly in the center of the sensor. This is suitable, for example, in conjunction with GaN-on-Si or also with micro-transfer printing. In order to avoid disturbing the optimization, at least subregions should be omitted from the size of the base matrix.

Only in the case of very small matrices can distributions still be practically generated and analyzed by means of “brute force”, e.g. by cycling through all possible meaningful permutations. In this way, for example, it is possible to prove retrospectively that there is no better submatrix than the previously optimized one, provided that it is small enough (e.g. 4×4).

To form larger matrices, basic operations such as copying, rotating, and reflection can be applied repeatedly to the base matrix or submatrix. By successive analysis of each of the newly formed matrices the best candidates are determined and, if necessary, a larger matrix is formed from them in turn. According to this scheme, the optimization of matrices even with 32×32=1024 or more elements can be achieved with acceptable computing time, although all possible permutations with 4\hat{ }1024 are unrealistically large. Especially in the case of more complex forms of the total matrix (for example, with free cells in the center or corners), it makes sense to use a procedure in which smaller matrices (the base matrix itself or low-order composite matrices) are placed on the larger target matrix instead of successively generating a binary enlargement with the matrix previously formed. When placing partial matrices in a larger matrix to be newly formed, symmetries can be taken into account from the outset to reduce the number of virtual experiments. The subsequent analysis of each newly formed matrix will in any case eliminate arrangements with poor symmetry, since these inevitably lead to larger measurement errors in the event of uneven illumination.

In order to analyze for suitability a partial or total matrix formed according to this scheme, at least one realistic intensity profile (e.g. the beam profile of an LED) is determined and a virtual exposure experiment is carried out, in which, for example, the position of the light source or its orientation with respect to the sensor is changed. Certain specifiable limits must be observed or set, such as the degree of displacement and the degree of intensity change over the entire sensor array. For each possible lighting situation in the virtual experiment, the total signal (e.g. the sum of the signals of all the sensor fields of the same type) is determined and the relative deviation from each other is determined. The worst value (the greatest deviation) determined from this process determines the maximum accuracy that the sensor can guarantee under the chosen circumstances. Different matrices can thus be compared with one another, wherein successively more enlarged matrices can be created from the best matrices each time. It is assumed that the errors of a poor small matrix are not transformed into an advantage for a larger matrix formed from them.

For the calculated summary intensities I₁ to I₄ of the distributed base elements 1 . . . 4, a usable error signal results, e.g., by determining (max(I₁, . . . , I₄)−min(I₁, . . . , I₄))/average(I₁ . . . , I₄), which is 0 in the ideal case and positive in the case of an error. The relative error thus determined can be used to a first approximation for estimating the angular accuracy of a polarization angle sensor, for example. A value of 1% roughly corresponds to 7 bits or just under 2°.

In the case of magnetic sensors or e.g. transistor arrangements, other equivalent experiments can of course be carried out instead of the virtual exposure experiment. For example, a heat distribution or a production-related gradient in production parameters could be used instead of the assumed exposure. This does not change the methodology, but if other profiles are assumed, different matrices can be set as optimal than in the case of assumed LED illumination.

Essentially, the trend is that a larger number of individual elements on the same surface area leads to a significantly smaller error. A quadrupling of their number on the same surface area leads to an accuracy gain of almost 2.7 bits in the cases examined. However, it is necessary to taken into account the fact that the elements must be insulated from each other and interconnected so that even if a minimum size is maintained for the individual elements, an increase in their number can ultimately be accompanied by an increase in the overall surface area. In this case, it must also be clarified whether a larger total matrix is not exposed to larger gradients than a smaller matrix, so that computational gains from optimization may not be feasible in practice. For example, at a given small distance between the light source and the sensor with a predetermined LED beam profile, it is clear that a sensor surface chosen too large cannot be fully illuminated. In this case, the criterion previously selected for the optimization (e.g. factor 2 difference in brightness) could not be adhered to in the application.

The synthesis of suitable submatrices can be carried out systematically. Suitable array structures are first obtained when square individual elements are arranged in an array with as many symmetries as possible. It is therefore convenient to combine point, axis, mirror and rotational symmetries where possible. This can lead to problems in certain places, such as the center. Therefore, it may be convenient to disregard individual positions in the array or to fill them with other functions. As well as the center, this also applies to the corners of a square matrix. The opposite corners would have a maximally deviating light intensity in the case of non-centered illumination and can therefore contribute to measurement errors to a particular extent. Thus, while the basic unit of the sensor (the unit cell EZ) of 4 individual sensors can most likely be formed by a square matrix, a larger array can be more likely based on an approximate circle, i.e. the corners can remain unused or be filled by other functions. This is particularly successful with high-order arrays.

The construction of successively larger matrices from a given base matrix or unit cell can be carried out with the aid of simple basic operations. These are e.g. vertical and horizontal reflection, diagonal reflection over both diagonals and 90° rotation of the elements (transposition).

From a base matrix

$$M = [ \begin{matrix}{a}_{11} & {a}_{12} \\ {a}_{21} & {a}_{22}\end{matrix} ]$$

successive application of modification operators will result in different variants of the base matrix, from which larger matrices can be formed using expansion operators. Suitable modification operators for a unit cell of 4 elements are, for example:
Reflection about the horizontal (up-dn-flip):

$$getFlippedUpDown ( M ) = [ \begin{matrix}{a}_{21} & {a}_{22} \\ {a}_{11} & {a}_{12}\end{matrix} ]$$

Reflection about the vertical (left-right-flip):

$$getFlippedLeftRight ( M ) = [ \begin{matrix}{a}_{12} & {a}_{11} \\ {a}_{22} & {a}_{21}\end{matrix} ]$$

Diagonal reflection (diagonal flip):

$$getFlippedDiag ( M ) = [ \begin{matrix}{a}_{22} & {a}_{21} \\ {a}_{12} & {a}_{11}\end{matrix} ]$$

Rotation to the right (turn):

$$turnMatrixRight ( M ) = [ \begin{matrix}{a}_{11} & {a}_{12} \\ {a}_{21} & {a}_{22}\end{matrix} ]$$

(first row becomes the last column, second row becomes the penultimate column etc., until the last row becomes the first column).

From an initial matrix EZ with n*n elements, for example, a new matrix M with 2n*2n elements can be easily created using expansion operators. The expansion operators fill the new matrix with variants of the initial matrix (M1 . . . M4) using the modification operators. Some examples of expansion operators are listed below:

$$M = OP ( EZ ) = [ \begin{matrix}M 1 & M 2 \\ M 3 & M 4\end{matrix} ] .$$

In the first step, the initial matrix has the dimension of the base matrix (e.g. 2×2 for 4 base elements). In subsequent steps, the best of the newly calculated matrices is instead used as the new initial matrix, so that, for example, a matrix with 32×32 base elements can be obtained in 4 iterations.

With the unit cell or base matrix EZ and the matrices M1-M4 modified by basic operators (OP) from the unit cell, appropriate operators are, for example
Expansion operator OP1:
   {M1=EZ, M2=vertically reflected EZ, M3=horizontally reflected EZ, M4=diagonally reflected EZ}
Expansion operator OP2:
   {M1=EZ, M2=EZ, M3=EZ, M4=EZ}
Expansion operator OP3: (Rotation by 90°, continuously clockwise or counter-clockwise)
   {M1=EZ, M2=Rotated M1, M4=Rotated M2, M3=Rotated M4}
Expansion operator OP4:
   {M1=EZ, M2=diagonally reflected EZ, M3=diagonally reflected EZ, M4=EZ}

Since it is not obvious which operators at which point lead to the best result, systematic creation and analysis is required. This leads again to a large number of experiments (several tens of thousands of variants and subsequent virtual exposure experiments to determine an optimal 32×32 matrix), but these can be carried out on currently available computers in a manageable time.

It should be noted that matrices produced in different ways (using different operators) can deliver equivalent results, even if they appear to be different at first glance. This is because, in principle, sensor fields of the same type are interchangeable with each other, in particular those base elements that belong to a differential pair can be swapped with each other—a cross-wise swapping of basic elements of an I and a Q signal, on the other hand, is not expedient. Furthermore, the copies produced by rotation are equivalent to the original. Shift operations also, at least by multiples of the base cell, are also usually harmless.

In principle, the procedure can be further generalized, i.e. applied to non-square matrices and/or the expansion can also be carried out in larger and non-binary steps. However, the variant presented here with square matrices and binary expansion is particularly simple to implement.

The 8×8 matrix shown in FIG. 1 (prior art) can also be generated in the manner described here from a smaller base matrix. Obviously, a 4×4 matrix is the size from which larger matrices can be created by simple copying (OP2). However, this 4×4 matrix cannot be formed from identical 2×2 matrices, since random 2×2 matrices in FIG. 1 do not contain all 4 base elements. This contradicts the principle that all elements should be located as close together as possible. However, it would be conceivable, and also consistent with this invention, to generate an 8×8 matrix or larger matrix from the same 4×4 base matrix using suitable operators. Thus, by applying e.g. OP1, one would obtain a more advantageous 8×8 matrix, for which mirror symmetry exists at least on a larger scale and consequently the centers of gravity of the individual elements coincide with each other again.

The respective figures accordingly also show an integrated circuit for measuring the polarization of light,
having polarization-sensitive sensors with different orientations of the polarization planes as base elements in preferably four different orientations (1,2,3,4),
having sensory elements, each arranged to cooperate as a structural unit with a polarization filter for one of the polarization-sensitive sensors,
wherein the polarization-sensitive filter of the polarization-sensitive sensor arranged as a structural unit has a specific extension and orientation,
wherein the polarization filter has lattice structures produced by lithographic methods in at least one fabrication layer,
wherein the polarization-sensitive sensors of different orientations consist of a plurality of individual sensor elements arranged in a matrix,
wherein in the integrated circuit, devices are provided which are configured to make a statement about the polarization of the incident light from the signals of the polarization-sensitive sensors,
wherein the base elements are arranged with different orientations (1,2,3,4) in a 8×8 matrix, and
wherein the base elements in the first row of the 8×8 matrix have the arrangement [1,2,3,4,2,1,4,3], those in the second row of the 8×8 matrix have the arrangement [4,3,2,1,3,4,1,2], those in the third row of the 8×8 matrix have the arrangement [3,4,1,2,4,3,2,1], those in the fourth row of the 8×8 matrix have the arrangement [2,1,4,3,1,2,3,4], those in the fifth row of the 8×8 matrix have the arrangement [4,3,2,1,3,4,1,2], those in the sixth row of the arrangement have the arrangement [1,2,3,4,2,1,4,3], those in the seventh row of the 8×8 matrix have the arrangement [2,1,4,3,1,2,3,4] and those in the eighth row of the 8×8 matrix have the arrangement [3,4,1,2,4,3,2,1].

The respective figures accordingly also show an integrated circuit for measuring the polarization of light,
having polarization-sensitive sensors with different orientations of the polarization planes as base elements in preferably four different orientations (1,2,3,4),
having sensory elements, each arranged to cooperate as a structural unit with a polarization filter for one of the polarization-sensitive sensors,
wherein the polarization-sensitive filter of the polarization-sensitive sensor arranged as a structural unit has a specific extension and orientation,
wherein the polarization filter has lattice structures produced by lithographic methods in at least one fabrication layer,
wherein the polarization-sensitive sensors of different orientations consist of a plurality of individual sensor elements arranged in a matrix,
wherein in the integrated circuit, devices are provided which are configured to make a statement about the polarization of the incident light from the signals of the polarization-sensitive sensors,
wherein the base elements are arranged with different orientations (1,2,3,4) in a 16×16 matrix, and
wherein
   a) the base elements in the first row of the 16×16 matrix have the arrangement [1,2,4,3,2,1,3,4, 1,2,4,3,2,1,3,4], those in the second row of the 16×16-Matrix have the arrangement [4,3,2,1,3,4,1,2, 4,3,2,1,3,4,1,2], those in the third row of the 16×16 matrix have the arrangement [3,4,1,2,4,3,2,1, 3,4,1,2,4,3,2,1], those in the fourth row of the 16×16 matrix have the arrangement [2,1,3,4,1,2,4,3, 2,1,3,4,1,2,4, 3], those in the fifth row of the 16×16 matrix have the arrangement [3,4,2,1,4,3,1,2, 3,4,2,1,4,3,1,2], those in the sixth row of the 16×16 matrix have the arrangement [1,2,3,4,2,1,4,3, 1,2,3,4,2,1,4,3], those in the seventh row of the 16×16 matrix have the arrangement [2,1,4,3,1,2,3,4, 2,1,4,3,1,2,3,4], those in the eighth row of the 16×16 matrix have the arrangement [4,3,1,2,3,4,2,1, 4,3,1,2,3,4,2,1], those in the ninth row of the 16×16 matrix have the arrangement [1,2,4,3,2,1,3,4, 1,2,4,3,2,1,3,4], those in the tenth row of the 16×16 matrix have the arrangement [4,3,2,1,3,4,1,2, 4,3,2,1,3,4,1,2], those in the eleventh row of the 16×16 matrix have the arrangement [3,4,1,2,4,3,2,1, 3,4,1,2,4,3,2,1], those in the twelfth row of the 16×16 matrix have the arrangement [2,1,3,4,1,2,4,3, 2,1,3,4,1,2,4, 3], those in the thirteenth row of the 16×16 matrix have the arrangement [3,4,2,1,4,3,1,2,3,4,2,1,4,3,1,2], those in the fourteenth row of the 16×16 matrix have the arrangement [1,2,3,4,2,1,4,3, 1,2,3,4,2,1,4,3], those in the fifteenth row of the 16×16 matrix have the arrangement [2,1,4,3,1,2,3,4, 2,1,4,3,1,2,3, 4], those in the sixteenth row of the 16×16 matrix have the arrangement [4,3,1,2,3,4,2,1, 4,3,1,2,3,4,2,1], or
   b) the base elements in the first row of the 16×16 matrix have the arrangement [1,2,3,4,2,3,4,1, 1,4,3,2,4,3,2,1], those in the second row of the 16×16 matrix have the arrangement [4,3,2,1,1,4,3,2, 2,3,4,1,1,2,3,4], those in the third row of the 16×16 matrix have the arrangement [3,4,1,2,4,1,2,3, 3,2,1,4,2,1,4,3], those in the fourth row of the 16×16 matrix have the arrangement [2,1,4,3,3,2,1,4, 4,1,2,3,3,4,1,2], those in the fifth row of the 16×16 matrix have the arrangement [4,1,2,3,3,4,1,2, 2,1,4,3,3,2,1,4], those in the sixth row of the 16×16 matrix have the arrangement [3,2,1,4,2,1,4,3, 3,4,1,2,4,1,2,3], those in the seventh row of the 16×16 matrix have the arrangement [2,3,4,1,1,2,3,4, 4,3,2,1,1,4,3,2], those in the eighth row of the 16×16 matrix have the arrangement [1,4,3,2,4,3,2,1, 1,2,3,4,2,3,4,1], those in the ninth row of the 16×16 matrix have the arrangement [1,4,3,2,4,3,2,1, 1,2,3,4,2,3,4,1], those in the tenth row of the 16×16 matrix have the arrangement [2,3,4,1,1,2,3,4, 4,3,2,1,1,4,3,2], those in the eleventh row of the 16×16 matrix have the arrangement [3,2,1,4,2,1,4,3, 3,4,1,2,4,1,2,3], those in the twelfth row of the 16×16 matrix have the arrangement [4,1,2,3,3,4,1,2, 2,1,4,3,3,2,1,4], those in the thirteenth row of the 16×16 matrix have the arrangement [2,1,4,3,3,2,1,4, 4,1,2,3,3,4,1,2], those in the fourteenth row of the 16×16 matrix have the arrangement [3,4,1,2,4,1,2,3, 3,2,1,4,2,1,4,3], those in the fifteenth row of the 16×16 matrix have the arrangement [4,3,2,1,1,4,3,2, 2,3,4,1,1,2,3,4], those in the sixteenth row of the 16×16 matrix have the arrangement [1,2,3,4,2,3,4,1, 1,4,3,2,4,3,2,1], or
   c) the base elements in the first row of the 16×16 matrix have the arrangement [1,2,3,4,1,2,3,4, 1,2,3,4,1,2,3,4], those in the second row of the 16×16 matrix have the arrangement [4,3,2,1,4,3,2,1, 4,3,2,1,4,3,2,1], those in the third row of the 16×16 matrix have the arrangement [3,4,1,2,3,4,1,2, 3,4,1,2,3,4,1,2], those in the fourth row of the 16×16 matrix have the arrangement [2,1,4,3,2,1,4,3, 2,1,4,3,2,1,4,3], those in the fifth row of the 16×16 matrix have the arrangement [1,2,3,4,1,2,3,4, 1,2,3,4,1,2,3,4], those in the sixth row of the 16×16 matrix have the arrangement [4,3,2,1,4,3,2,1, 4,3,2,1,4,3,2,1], those in the seventh row of the 16×16 matrix have the arrangement [3,4,1,2,3,4,1,2, 3,4,1,2,3,4,1,2], those in the eighth row of the 16×16 matrix have the arrangement [2,1,4,3,2,1,4,3, 2,1,4,3,2,1,4,3], those in the ninth row of the 16×16 matrix have the arrangement [1,2,3,4,1,2,3,4, 1,2,3,4,1,2,3, 4], those in the tenth row of the 16×16 matrix have the arrangement [4,3,2,1,4,3,2,1, 4,3,2,1,4,3,2,1], those in the eleventh row of the 16×16 matrix have the arrangement [3,4,1,2,3,4,1,2, 3,4,1,2,3,4,1,2], those in the twelfth row of the 16×16 matrix have the arrangement [2,1,4,3,2,1,4,3, 2,1,4,3,2,1,4,3], those in the thirteenth row of the 16×16 matrix have the arrangement [1,2,3,4,1,2,3,4, 1,2,3,4,1,2,3,4], those in the fourteenth row of the 16×16 matrix have the arrangement [4,3,2,1,4,3,2,1, 4,3,2,1,4,3,2,1], those in the fifteenth row of the 16×16 matrix have the arrangement [3,4,1,2,3,4,1,2, 3,4,1,2,3,4,1,2], those in the sixteenth row of the 16×16 matrix have the arrangement [2,1,4,3,2,1,4,3, 2,1,4,3,2,1,4,3], or
   d) the base elements in the first row of the 16×16 matrix have the arrangement [1,2,3,4,2,1,4,3, 1,2,3,4,2,1,4, 3], those in the second row of the 16×16 matrix have the arrangement [4,3,2,1,3,4,1,2, 4,3,2,1,3,4,1,2], those in the third row of the 16×16 matrix have the arrangement [3,4,1,2,4,3,2,1, 3,4,1,2,4,3,2,1], those in the fourth row of the 16×16 matrix have the arrangement [2,1,4,3,1,2,3,4, 2,1,4,3,1,2,3,4], those in the fifth row of the 16×16 matrix have the arrangement [4,3,2,1,3,4,1,2, 4,3,2,1,3,4,1,2], those in the sixth row of the 16×16 matrix have the arrangement [1,2,3,4,2,1,4,3, 1,2,3,4,2,1,4,3], those in the seventh row of the 16×16 matrix have the arrangement [2,1,4,3,1,2,3,4, 2,1,4,3,1,2,3,4], those in the eighth row of the 16×16 matrix have the arrangement [3,4,1,2,4,3,2,1, 3,4,1,2,4,3,2,1], those in the ninth row of the 16×16 matrix have the arrangement [1,2,3,4,2,1,4,3, 1,2,3,4,2,1,4,3], those in the tenth row of the 16×16 matrix have the arrangement [4,3,2,1,3,4,1,2, 4,3,2,1,3,4,1,2], those in the eleventh row of the 16×16 matrix have the arrangement [3,4,1,2,4,3,2,1, 3,4,1,2,4,3,2,1], those in the twelfth row of the 16×16 matrix have the arrangement [2,1,4,3,1,2,3,4, 2,1,4,3,1,2,3,4], those in the thirteenth row of the 16×16 matrix have the arrangement [4,3,2,1,3,4,1,2, 4,3,2,1,3,4,1,2], those in the fourteenth row of the 16×16 matrix have the arrangement [1,2,3,4,2,1,4,3, 1,2,3,4,2,1,4,3], those in the fifteenth row of the 16×16 matrix have the arrangement [2,1,4,3,1,2,3,4, 2,1,4,3,1,2,3,4], those in the sixteenth row of the 16×16 matrix have the arrangement [3,4,1,2,4,3,2,1, 3,4,1,2,4,3,2,1].

The respective figures accordingly also show an integrated circuit for measuring the polarization of light,
having polarization-sensitive sensors with different orientations of the polarization planes as base elements in preferably four different orientations (1,2,3,4),
having sensory elements, each arranged to cooperate as a structural unit with a polarization filter for one of the polarization-sensitive sensors,
wherein the polarization-sensitive filter of the polarization-sensitive sensor arranged as a structural unit has a specific extension and orientation,
wherein the polarization filter has lattice structures produced by lithographic methods in at least one fabrication layer,
wherein the polarization-sensitive sensors of different orientations consist of a plurality of individual sensor elements arranged in a matrix,
wherein in the integrated circuit, devices are provided which are configured to make a statement about the polarization of the incident light from the signals of the polarization-sensitive sensors,
wherein the base elements are arranged with different orientations (1,2,3,4) in a 32×32 matrix, and
wherein
   a) the base elements in the first row of the 16×16 matrix have the arrangement [12341234 23412341 12341234 23412341], those in the second row of the 32×32 matrix have the arrangement [43214321 14321432 43214321 14321432], those in the third row of the 32×32 matrix have the arrangement [34123412 41234123 34123412 41234123], those in the fourth row of the 32×32 matrix have the arrangement [21432143 32143214 21432143 32143214], those in the fifth row of the 32×32 matrix have the arrangement [12341234 23412341 12341234 23412341], those in the sixth row of the 32×32 matrix have the arrangement [43214321 14321432 43214321 14321432], those in the seventh row of the 32×32 matrix have the arrangement [34123412 41234123 34123412 41234123], those in the eighth row of the 32×32 matrix have the arrangement [21432143 32143214 21432143 32143214], those in the ninth row of the 32×32 matrix have the arrangement [41234123 34123412 41234123 34123412], those in the tenth row of the 32×32 matrix have the arrangement [32143214 21432143 32143214 21432143], those in the eleventh row of the 32×32 matrix have the arrangement [23412341 12341234 23412341 12341234], those in the twelfth row of the 32×32 matrix have the arrangement [14321432 43214321 14321432 43214321], those in the 13th row of the 32×32 matrix have the arrangement [41234123 34123412 41234123 34123412], those in the 14th row of the 32×32 matrix have the arrangement [32143214 21432143 32143214 21432143], those in the 15th row of the 32×32 matrix have the arrangement [23412341 12341234 23412341 12341234], those in the 16th row of the 32×32 matrix have the arrangement [14321432 43214321 14321432 43214321], those in the 17th row of the 32×32 matrix have the arrangement [12341234 23412341 12341234 23412341], those in the 18th row of the 32×32 matrix have the arrangement [43214321 14321432 43214321 14321432], those in the 19th row of the 32×32 matrix have the arrangement [34123412 41234123 34123412 41234123], those in the 20th row of the 32×32 matrix have the arrangement [21432143 32143214 21432143 32143214], those in the 21st row of the 32×32 matrix have the arrangement [12341234 23412341 12341234 23412341], those in the 22nd row of the 32×32 matrix have the arrangement [43214321 14321432 43214321 14321432], those in the 23rd row of the 32×32 matrix have the arrangement [34123412 41234123 34123412 41234123], those in the 24th row of the 32×32 matrix have the arrangement [21432143 32143214 21432143 32143214], those in the 25th row of the 32×32 matrix have the arrangement [41234123 34123412 41234123 34123412], those in the 26th row of the 32×32 matrix have the arrangement [32143214 21432143 32143214 21432143], those in the 27th row of the 32×32 matrix have the arrangement [23412341 12341234 23412341 12341234], those in the 28th row of the 32×32 matrix have the arrangement [14321432 43214321 14321432 43214321], those in the 29th row of the 32×32 matrix have the arrangement [41234123 34123412 41234123 34123412], those in the 30th row of the 32×32 matrix have the arrangement [32143214 21432143 32143214 21432143], those in the 31st row of the 32×32 matrix have the arrangement [23412341 12341234 23412341 12341234], those in the 32nd row of the 32×32 matrix have the arrangement [14321432 43214321 14321432 43214321], or
   b) the base elements in the first row of the 32×32 matrix have the arrangement [12342341 14324321 12342341 14324321], those in the second row of the 32×32 matrix have the arrangement [43211432 23411234 43211432 23411234], those in the third row of the 32×32 matrix have the arrangement [34123412 41234123 34123412 34123412], those in the fourth row of the 32×32 matrix have the arrangement [21433214 41233412 21433214 41233412], those in the fifth row of the 32×32 matrix have the arrangement [41233412 21433214 41233412 21433214], those in the sixth row of the 32×32 matrix have the arrangement [32142143 34124123 32142143 34124123], those in the seventh row of the 32×32 matrix have the arrangement [23411234 43211432 23411234 43211432] those in the eighth row of the 32×32 matrix have the arrangement [14324321 12342341 14324321 12342341], those in the ninth row of the 32×32 matrix have the arrangement [14324321 12342341 14324321 12342341], those in the tenth row of the 32×32 matrix have the arrangement [23411234 43211432 23411234 43211432], those in the eleventh row of the 32×32 matrix have the arrangement [32142143 34124123 32142143 34124123], those in the twelfth row of the 32×32 matrix have the arrangement [41233412 21433214 41233412 21433214], those in the 13th row of the 32×32 matrix have the arrangement [21433214 41233412 21433214 41233412], those in the 14th row of the 32×32 matrix have the arrangement [34124123 32142143 34124123 32142143], those in the 15th row of the 32×32 matrix have the arrangement [43211432 23411234 43211432 23411234], those in the 16th row of the 32×32 matrix have the arrangement [12342341 14324321 12342341 14324321], those in the 17th row of the 32×32 matrix have the arrangement [12342341 14324321 12342341 14324321], those in the 18th row of the 32×32 matrix have the arrangement [43211432 23411234 43211432 23411234], those in the 19th row of the 32×32 matrix have the arrangement [34124123 32142143 34124123 32142143], those in the 20th row of the 32×32 matrix have the arrangement [21433214 41233412 21433214 41233412], those in the 21st row of the 32×32 matrix have the arrangement [41233412 21433214 41233412 21433214], those in the 22nd row of the 32×32 matrix have the arrangement [32142143 34124123 32142143 34124123], those in the 23rd row of the 32×32 matrix have the arrangement [23411234 43211432 23411234 43211432], those in the 24th row of the 32×32 matrix have the arrangement [14324321 12342341 14324321 12342341], those in the 25th row of the 32×32 matrix have the arrangement [14324321 12342341 14324321 12342341], those in the 26th row of the 32×32 matrix have the arrangement [23411234 43211432 23411234 43211432], those in the 27th row of the 32×32 matrix have the arrangement [32142143 34124123 32142143 34124123], those in the 28th row of the 32×32 matrix have the arrangement [41233412 21433214 41233412 21433214], those in the 29th row of the 32×32 matrix have the arrangement [21433214 41233412 21433214 41233412], those in the 30th row of the 32×32 matrix have the arrangement [34124123 32142143 34124123 32142143], those in the 31st row of the 32×32 matrix have the arrangement [43211432 23411234 43211432 23411234], those in the 32nd row of the 32×32 matrix have the arrangement [12342341 14324321 12342341 14324321], or
   c) the base elements in the first row of the 32×32 matrix have the arrangement [12341234 21432143 12341234 21432143], those in the second row of the 32×32 matrix have the arrangement [43214321 34123412 43214321 34123412], those in the third row of the 32×32 matrix have the arrangement [34123412 43214321 34123412 43214321], those in the fourth row of the 32×32 matrix have the arrangement [21432143 12341234 21432143 12341234], those in the fifth row of the 32×32 matrix have the arrangement [12341234 21432143 12341234 21432143], those in the sixth row of the 32×32 matrix have the arrangement [43214321 34123412 43214321 34123412], those in the seventh row of the 32×32 matrix have the arrangement [34123412 43214321 34123412 43214321], those in the eighth row of the 32×32 matrix have the arrangement [21432143 12341234 21432143 12341234], those in the ninth row of the 32×32 matrix have the arrangement [43214321 34123412 43214321 34123412], those in the tenth row of the 32×32 matrix have the arrangement [12341234 21432143 12341234 21432143], those in the eleventh row of the 32×32 matrix have the arrangement [21432143 12341234 21432143 12341234], those in the twelfth row of the 32×32 matrix have the arrangement [34123412 43214321 34123412 43214321], those in the 13th row of the 32×32 matrix have the arrangement [43214321 34123412 43214321 34123412], those in the 14th row of the 32×32 matrix have the arrangement [12341234 21432143 12341234 21432143], those in the 15th row of the 32×32 matrix have the arrangement [21432143 12341234 21432143 12341234], those in the 16th row of the 32×32 matrix have the arrangement [34123412 43214321 34123412 43214321], those in the 17th row of the 32×32 matrix have the arrangement [12341234 21432143 12341234 21432143], those in the 18th row of the 32×32 matrix have the arrangement [43214321 34123412 43214321 34123412], those in the 19th row of the 32×32 matrix have the arrangement [34123412 43214321 34123412 43214321], those in the 20th row of the 32×32 matrix have the arrangement [21432143 12341234 21432143 12341234], those in the 21st row of the 32×32 matrix have the arrangement [12341234 21432143 12341234 21432143], those in the 22nd row of the 32×32 matrix have the arrangement [43214321 34123412 43214321 34123412], those in the 23rd row of the 32×32 matrix have the arrangement [34123412 43214321 34123412 43214321], those in the 24th row of the 32×32 matrix have the arrangement [21432143 12341234 21432143 12341234], those in the 25th row of the 32×32 matrix have the arrangement [43214321 34123412 43214321 34123412], those in the 26th row of the 32×32 matrix have the arrangement [12341234 21432143 12341234 21432143], those in the 27th row of the 32×32 matrix have the arrangement [21432143 12341234 21432143 12341234], those in the 28th row of the 32×32 matrix have the arrangement [34123412 43214321 34123412 43214321], those in the 29th row of the 32×32 matrix have the arrangement [43214321 34123412 43214321 34123412], those in the 30th row of the 32×32 matrix have the arrangement [12341234 21432143 12341234 21432143], those in the 31st row of the 32×32 matrix have the arrangement [21432143 12341234 21432143 12341234], those in the 32nd row of the 32×32 matrix have the arrangement [34123412 43214321 34123412 43214321], or
   d) the base elements in the first row of the 32×32 matrix have the arrangement [12342341 12342341 12342341 12342341], those in the second row of the 32×32 matrix have the arrangement [43211432 43211432 43211432 43211432], those in the third row of the 32×32 matrix have the arrangement [34124123 34124123 34124123 34124123], those in the fourth row of the 32×32 matrix have the arrangement [21433214 21433214 21433214 21433214], those in the fifth row of the 32×32 matrix have the arrangement [41233412 41233412 41233412 41233412], those in the sixth row of the 32×32 matrix have the arrangement [32142143 32142143 32142143 32142143], those in the seventh row of the 32×32 matrix have the arrangement [23411234 23411234 23411234 23411234], those in the eighth row of the 32×32 matrix have the arrangement [14324321 14324321 14324321 14324321], those in the ninth row of the 32×32 matrix have the arrangement [12342341 12342341 12342341 12342341], those in the tenth row of the 32×32 matrix have the arrangement [43211432 43211432 43211432 43211432], those in the eleventh row of the 32×32 matrix have the arrangement [34124123 34124123 34124123 34124123], those in the twelfth row of the 32×32 matrix have the arrangement [21433214 21433214 21433214 21433214], those in the 13th row of the 32×32 matrix have the arrangement [41233412 41233412 41233412 41233412], those in the 14th row of the 32×32 matrix have the arrangement [32142143 32142143 32142143 32142143], those in the 15th row of the 32×32 matrix have the arrangement [23411234 23411234 23411234 23411234], those in the 16th row of the 32×32 matrix have the arrangement [14324321 14324321 14324321 14324321], those in the 17th row of the 32×32 matrix have the arrangement [12342341 12342341 12342341 12342341], those in the 18th row of the 32×32 matrix have the arrangement [43211432 43211432 43211432 43211432], those in the 19th row of the 32×32 matrix have the arrangement [34124123 34124123 34124123 34124123], those in the 20th row of the 32×32 matrix have the arrangement [21433214 21433214 21433214 21433214], those in the 21st row of the 32×32 matrix have the arrangement [41233412 41233412 41233412 41233412], those in the 22nd row of the 32×32 matrix have the arrangement [32142143 32142143 32142143 32142143], those in the 23rd row of the 32×32 matrix have the arrangement [23411234 23411234 23411234 23411234], those in the 24th row of the 32×32 matrix have the arrangement [14324321 14324321 14324321 14324321], those in the 25th row of the 32×32 matrix have the arrangement [12342341 12342341 12342341 12342341], those in the 26th row of the 32×32 matrix have the arrangement [43211432 43211432 43211432 43211432], those in the 27th row of the 32×32 matrix have the arrangement [34124123 34124123 34124123 34124123], those in the 28th row of the 32×32 matrix have the arrangement [21433214 21433214 21433214 21433214], those in the 29th row of the 32×32 matrix have the arrangement [41233412 41233412 41233412 41233412], those in the 30th row of the 32×32 matrix have the arrangement [32142143 32142143 32142143 32142143], those in the 31st row of the 32×32 matrix have the arrangement [23411234 23411234 23411234 23411234], those in the 32nd row of the 32×32 matrix have the arrangement [14324321 14324321 14324321 14324321], or
   e) the base elements in the first row of the 32×32 matrix have the arrangement [12342143 12342143 12342143 12342143], those in the second row of the 32×32 matrix have the arrangement [43213412 43213412 43213412 43213412], those in the third row of the 32×32 matrix have the arrangement [34124321 34124321 34124321 34124321], those in the fourth row of the 32×32 matrix have the arrangement [21431234 21431234 21431234 21431234], those in the fifth row of the 32×32 matrix have the arrangement [43213412 43213412 43213412 43213412], those in the sixth row of the 32×32 matrix have the arrangement [12342143 12342143 12342143 12342143], those in the seventh row of the 32×32 matrix have the arrangement [21431234 21431234 21431234 21431234], those in the eighth row of the 32×32 matrix have the arrangement [34124321 34124321 34124321 34124321], those in the ninth row of the 32×32 matrix have the arrangement [12342341 12342341 12342341 12342341], those in the tenth row of the 32×32 matrix have the arrangement [43213412 43213412 43213412 43213412], those in the eleventh row of the 32×32 matrix have the arrangement [34124321 34124321 34124321 34124321], those in the twelfth row of the 32×32 matrix have the arrangement [21431234 21431234 21431234 21431234], those in the 13th row of the 32×32 matrix have the arrangement [43213412 43213412 43213412 43213412], those in the 14th row of the 32×32 matrix have the arrangement [12342143 12342143 12342143 12342143], those in the 15th row of the 32×32 matrix have the arrangement [21431234 21431234 21431234 21431234], those in the 16th row of the 32×32 matrix have the arrangement [34124321 34124321 34124321 34124321], those in the 17th row of the 32×32 matrix have the arrangement [12342143 12342143 12342143 12342143], those in the 18th row of the 32×32 matrix have the arrangement [43213412 43213412 43213412 43213412], those in the 19th row of the 32×32 matrix have the arrangement [34124321 34124321 34124321 34124321], those in the 20th row of the 32×32 matrix have the arrangement [21431234 21431234 21431234 21431234], those in the 21st row of the 32×32 matrix have the arrangement [43213412 43213412 43213412 43213412], those in the 22nd row of the 32×32 matrix have the arrangement [12342143 12342143 12342143 12342143], those in the 23rd row of the 32×32 matrix have the arrangement [21431234 21431234 21431234 21431234], those in the 24th row of the 32×32 matrix have the arrangement [34124321 34124321 34124321 34124321], those in the 25th row of the 32×32 matrix have the arrangement [12342143 12342143 12342143 12342143], those in the 26th row of the 32×32 matrix have the arrangement [43213412 43213412 43213412 43213412], those in the 27th row of the 32×32 matrix have the arrangement [34124321 34124321 34124321 34124321], those in the 28th row of the 32×32 matrix have the arrangement [21431234 21431234 21431234 21431234], those in the 29th row of the 32×32 matrix have the arrangement [43213412 43213412 43213412 43213412], those in the 30th row of the 32×32 matrix have the arrangement [12342143 12342143 12342143 12342143], those in the 31st row of the 32×32 matrix have the arrangement [21431234 21431234 21431234 21431234], those in the 32nd row of the 32×32 matrix have the arrangement [34124321 34124321 34124321 34124321].

Accordingly, the respective figures also show an integrated circuit for measuring the polarization of light, in which individual positions of the matrix-like arrangement remain unoccupied.

The respective figures accordingly also show an integrated circuit for measuring the polarization of light,
wherein the polarization filter has lattice structures produced by lithographic methods in at least one fabrication layer and/or wiring layer,
wherein between the regions with lattice structures there are optically opaque walls present, which prevent interference from adjacent sensors under oblique incident light, and
wherein the optically opaque walls are produced by vias or contacts.

1-13. (canceled)

14. A method for iteratively generating a matrix of base elements, the method comprising:
first forming at least one base matrix containing at least all base elements, wherein said at least one base matrix may also contain empty elements, said empty elements being positions that are not occupied by one of the base elements;
applying modification operators iteratively, which are able to transform the base matrix or any matrix arising therefrom into a modified matrix;
applying expansion operators iteratively, which form a larger matrix from a plurality of optionally modified smaller matrices from the preceding iteration by copying, rotation or reflection by virtue of parts of the larger matrix being filled with the optionally modified smaller matrices;
performing virtual experiments within the scope of which the properties of a created matrix are examined by systematic creation of values deliberately containing errors from which an error signal is derivable; and
in order to create a complex matrix, forming all permutations of next larger matrices by applying expansion operators and then evaluating by means of virtual experiments, the next larger matrices selected with the smallest error signals, and then forming the next larger matrices successively therefrom by applying expansion operators and evaluating by means of virtual experiments until the error signal drops below a given limit.

15. An arrangement of a plurality of four different base elements (1,2,3,4) into an 8×8 matrix, wherein the base elements in the first row of the 8×8 matrix have the arrangement [1,2,3,4,2,1,4,3], those in the second row of the 8×8 matrix have the arrangement [4,3,2,1,3,4,1,2], those in the third row of the 8×8 matrix have the arrangement [3,4,1,2,4,3,2,1], those in the fourth row of the 8×8 matrix have the arrangement [2,1,4,3,1,2,3,4], those in the fifth row of the 8×8 matrix have the arrangement [4,3,2,1,3,4,1,2], those in the sixth row of the arrangement have the arrangement [1,2,3,4,2,1,4,3], those in the seventh row of the 8×8 matrix have the arrangement [2,1,4,3,1,2,3,4] and those in the eighth row of the 8×8 matrix have the arrangement [3,4,1,2,4,3,2,1].

16. An arrangement of a plurality of four different base elements (1,2,3,4) into a 16×16 matrix, wherein:
a) the base elements in the first row of the 16×16 matrix have the arrangement [1,2,4,3,2,1,3,4,1,2,4,3,2,1,3,4], those in the second row of the 16×16 matrix have the arrangement [4,3,2,1,3,4,1,2,4,3,2,1,3,4,1,2], those in the third row of the 16×16 matrix have the arrangement [3,4,1,2,4,3,2,1,3,4,1,2,4,3,2,1], those in the fourth row of the 16×16 matrix have the arrangement [2,1,3,4,1,2,4,3,2,1,3,4,1,2,4,3], those in the fifth row of the 16×16 matrix have the arrangement [3,4,2,1,4,3,1,2,3,4,2,1,4,3,1,2], those in the sixth row of the 16×16 matrix have the arrangement [1,2,3,4,2,1,4,3,1,2,3,4,2,1,4,3], those in the seventh row of the 16×16 matrix have the arrangement [2,1,4,3,1,2,3,4,2,1,4,3,1,2,3,4], those in the eighth row of the 16×16 matrix have the arrangement [4,3,1,2,3,4,2,1,4,3,1,2,3,4,2,1], those in the ninth row of the 16×16 matrix have the arrangement [1,2,4,3,2,1,3,4,1,2,4,3,2,1,3,4], those in the tenth row of the 16×16 matrix have the arrangement [4,3,2,1,3,4,1,2,4,3,2,1,3,4,1,2], those in the eleventh row of the 16×16 matrix have the arrangement [3,4,1,2,4,3,2,1,3,4,1,2,4,3,2,1], those in the twelfth row of the 16×16 matrix have the arrangement [2,1,3,4,1,2,4,3,2,1,3,4,1,2,4,3], those in the thirteenth row of the 16×16 matrix have the arrangement [3,4,2,1,4,3,1,2,3,4,2,1,4,3,1,2], those in the fourteenth row of the 16×16 matrix have the arrangement [1,2,3,4,2,1,4,3,1,2,3,4,2,1,4,3], those in the fifteenth row of the 16×16 matrix have the arrangement [2,1,4,3,1,2,3,4,2,1,4,3,1,2,3,4], those in the sixteenth row of the 16×16 matrix have the arrangement [4,3,1,2,3,4,2,1,4,3,1,2,3,4,2,1], or
b) the base elements in the first row of the 16×16 matrix have the arrangement [1,2,3,4,2,3,4,1,1,4,3,2,4,3,2,1], those in the second row of the 16×16 matrix have the arrangement [4,3,2,1,1,4,3,2,2,3,4,1,1,2,3,4], those in the third row of the 16×16 matrix have the arrangement [3,4,1,2,4,1,2,3,3,2,1,4,2,1,4,3], those in the fourth row of the 16×16 matrix have the arrangement [2,1,4,3,3,2,1,4,4,1,2,3,3,4,1,2], those in the fifth row of the 16×16 matrix have the arrangement [4,1,2,3,3,4,1,2,2,1,4,3,3,2,1,4], those in the sixth row of the 16×16 matrix have the arrangement [3,2,1,4,2,1,4,3,3,4,1,2,4,1,2,3], those in the seventh row of the 16×16 matrix have the arrangement [2,3,4,1,1,2,3,4,4,3,2,1,1,4,3,2], those in the eighth row of the 16×16 matrix have the arrangement [1,4,3,2,4,3,2,1,1,2,3,4,2,3,4,1], those in the ninth row of the 16×16 matrix have the arrangement [1,4,3,2,4,3,2,1,1,2,3,4,2,3,4,1], those in the tenth row of the 16×16 matrix have the arrangement [2,3,4,1,1,2,3,4,4,3,2,1,1,4,3,2], those in the eleventh row of the 16×16 matrix have the arrangement [3,2,1,4,2,1,4,3 3,4,1,2,4,1,2,3], those in the twelfth row of the 16×16 matrix have the arrangement [4,1,2,3,3,4,1,2,2,1,4,3,3,2,1,4], those in the thirteenth row of the 16×16 matrix have the arrangement [2,1,4,3,3,2,1,4,4,1,2,3,3,4,1,2], those in the fourteenth row of the 16×16 matrix have the arrangement [3,4,1,2,4,1,2,3,3,2,1,4,2,1,4,3], those in the fifteenth row of the 16×16 matrix have the arrangement [4,3,2,1,1,4,3,2,2,3,4,1,1,2,3,4], those in the sixteenth row of the 16×16 matrix have the arrangement [1,2,3,4,2,3,4,1,1,4,3,2,4,3,2,1], or
c) the base elements in the first row of the 16×16 matrix have the arrangement [1,2,3,4,1,2,3,4,1,2,3,4,1,2,3,4], those in the second row of the 16×16 matrix have the arrangement [4,3,2,1,4,3,2,1,4,3,2,1,4,3,2,1], those in the third row of the 16×16 matrix have the arrangement [3,4,1,2,3,4,1,2, 3,4,1,2,3,4,1,2], those in the fourth row of the 16×16 matrix have the arrangement [2,1,4,3,2,1,4,3,2,1,4,3,2,1,4,3], those in the fifth row of the 16×16 matrix have the arrangement [1,2,3,4,1,2,3,4,1,2,3,4,1,2,3,4], those in the sixth row of the 16×16 matrix have the arrangement [4,3,2,1,4,3,2,1,4,3,2,1,4,3,2,1], those in the seventh row of the 16×16 matrix have the arrangement [3,4,1,2,3,4,1,2,3,4,1,2,3,4,1,2], those in the eighth row of the 16×16 matrix have the arrangement [2,1,4,3,2,1,4,3,2,1,4,3,2,1,4,3], those in the ninth row of the 16×16 matrix have the arrangement [1,2,3,4,1,2,3,4,1,2,3,4,1,2,3,4], those in the tenth row of the 16×16 matrix have the arrangement [4,3,2,1,4,3,2,1,4,3,2,1,4,3,2,1], those in the eleventh row of the 16×16 matrix have the arrangement [3,4,1,2,3,4,1,2,3,4,1,2,3,4,1,2], those in the twelfth row of the 16×16 matrix have the arrangement [2,1,4,3,2,1,4,3,2,1,4,3,2,1,4,3], those in the thirteenth row of the 16×16 matrix have the arrangement [1,2,3,4,1,2,3,4,1,2,3,4,1,2,3,4], those in the fourteenth row of the 16×16 matrix have the arrangement [4,3,2,1,4,3,2,1,4,3,2,1,4,3,2,1], those in the fifteenth row of the 16×16 matrix have the arrangement [3,4,1,2,3,4,1,2,3,4,1,2,3,4,1,2], those in the sixteenth row of the 16×16 matrix have the arrangement [2,1,4,3,2,1,4,3,2,1,4,3,2,1,4,3], or
d) the base elements in the first row of the 16×16 matrix have the arrangement [1,2,3,4,2,1,4,3,1,2,3,4,2,1,4,3], those in the second row of the 16×16 matrix have the arrangement [4,3,2,1,3,4,1,2,4,3,2,1,3,4,1,2], those in the third row of the 16×16 matrix have the arrangement [3,4,1,2,4,3,2,1,3,4,1,2,4,3,2,1], those in the fourth row of the 16×16 matrix have the arrangement [2,1,4,3,1,2,3,4,2,1,4,3,1,2,3,4], those in the fifth row of the 16×16 matrix have the arrangement [4,3,2,1,3,4,1,2,4,3,2,1,3,4,1,2], those in the sixth row of the 16×16 matrix have the arrangement [1,2,3,4,2,1,4,3,1,2,3,4,2,1,4,3], those in the seventh row of the 16×16 matrix have the arrangement [2,1,4,3,1,2,3,4,2,1,4,3,1,2,3,4], those in the eighth row of the 16×16 matrix have the arrangement [3,4,1,2,4,3,2,1,3,4,1,2,4,3,2,1], those in the ninth row of the 16×16 matrix have the arrangement [1,2,3,4,2,1,4,3,1,2,3,4,2,1,4,3], those in the tenth row of the 16×16 matrix have the arrangement [4,3,2,1,3,4,1,2,4,3,2,1,3,4,1,2], those in the eleventh row of the 16×16 matrix have the arrangement [3,4,1,2,4,3,2,1,3,4,1,2,4,3,2,1], those in the twelfth row of the 16×16 matrix have the arrangement [2,1,4,3,1,2,3,4,2,1,4,3,1,2,3,4], those in the thirteenth row of the 16×16 matrix have the arrangement [4,3,2,1,3,4,1,2,4,3,2,1,3,4,1,2], those in the fourteenth row of the 16×16 matrix have the arrangement [1,2,3,4,2,1,4,3,1,2,3,4,2,1,4,3], those in the fifteenth row of the 16×16 matrix have the arrangement [2,1,4,3,1,2,3,4,2,1,4,3,1,2,3,4], those in the sixteenth row of the 16×16 matrix have the arrangement [3,4,1,2,4,3,2,1,3,4,1,2,4,3,2,1].

17. An arrangement of a plurality of four different base elements (1,2,3,4) into a 32×32 matrix, wherein:
a) the base elements in the first row have the arrangement [12341234 23412341 12341234 23412341], those in the second row of the 32×32 matrix have the arrangement [43214321 14321432 43214321 14321432], those in the third row of the 32×32 matrix have the arrangement [34123412 41234123 34123412 41234123], those in the fourth row of the 32×32 matrix have the arrangement [21432143 32143214 21432143 32143214], those in the fifth row of the 32×32 matrix have the arrangement [12341234 23412341 12341234 23412341], those in the sixth row of the 32×32 matrix have the arrangement [43214321 14321432 43214321 14321432], those in the seventh row of the 32×32 matrix have the arrangement [34123412 41234123 34123412 41234123], those in the eighth row of the 32×32 matrix have the arrangement [21432143 32143214 21432143 32143214], those in the ninth row of the 32×32 matrix have the arrangement [41234123 34123412 41234123 34123412], those in the tenth row of the 32×32 matrix have the arrangement [12341234 21432143 32143214 21432143], those in the eleventh row of the 32×32 matrix have the arrangement [23412341 12341234 23412341 12341234], those in the twelfth row of the 32×32 matrix have the arrangement [14321432 43214321 14321432 43214321], those in the 13th row of the 32×32 matrix have the arrangement [41234123 34123412 41234123 34123412], those in the 14th row of the 32×32 matrix have the arrangement [32143214 21432143 32143214 21432143], those in the 15th row of the 32×32 matrix have the arrangement [23412341 12341234 23412341 12341234], those in the 16th row of the 32×32 matrix have the arrangement [14321432 43214321 14321432 43214321], those in the 17th row of the 32×32 matrix have the arrangement [12341234 23412341 12341234 23412341], those in the 18th row of the 32×32 matrix have the arrangement [43214321 14321432 43214321 14321432], those in the 19th row of the 32×32 matrix have the arrangement [34123412 41234123 34123412 41234123], those in the 20th row of the 32×32 matrix have the arrangement [21432143 32143214 21432143 32143214], those in the 21st row of the 32×32 matrix have the arrangement [12341234 23412341 12341234 23412341], those in the 22nd row of the 32×32 matrix have the arrangement [43214321 14321432 43214321 14321432], those in the 23rd row of the 32×32 matrix have the arrangement [34123412 41234123 34123412 41234123], those in the 24th row of the 32×32 matrix have the arrangement [21432143 32143214 21432143 32143214], those in the 25th row of the 32×32 matrix have the arrangement [41234123 34123412 41234123 34123412], those in the 26th row of the 32×32 matrix have the arrangement [32143214 21432143 32143214 21432143], those in the 27th row of the 32×32 matrix have the arrangement [23412341 12341234 23412341 12341234], those in the 28th row of the 32×32 matrix have the arrangement [14321432 43214321 14321432 43214321], those in the 29th row of the 32×32 matrix have the arrangement [41234123 34123412 41234123 34123412], those in the 30th row of the 32×32 matrix have the arrangement [32143214 21432143 32143214 21432143], those in the 31st row of the 32×32 matrix have the arrangement [23412341 12341234 23412341 12341234], those in the 32nd row of the 32×32 matrix have the arrangement [14321432 43214321 14321432 43214321], or
b) the base elements in the first row of the 32×32 matrix have the arrangement [12342341 14324321 12342341 14324321], those in the second row of the 32×32 matrix have the arrangement [43211432 23411234 43211432 23411234], those in the third row of the 32×32 matrix have the arrangement [34123412 41234123 34123412 34123412], those in the fourth row of the 32×32 matrix have the arrangement [21433214 41233412 21433214 41233412], those in the fifth row of the 32×32 matrix have the arrangement [41233412 21433214 41233412 21433214], those in the sixth row of the 32×32 matrix have the arrangement [32142143 34124123 32142143 34124123], those in the seventh row of the 32×32 matrix have the arrangement [23411234 43211432 23411234 43211432] those in the eighth row of the 32×32 matrix have the arrangement [14324321 12342341 14324321 12342341], those in the ninth row of the 32×32 matrix have the arrangement [14324321 12342341 14324321 12342341], those in the tenth row of the 32×32 matrix have the arrangement [23411234 43211432 23411234 43211432], those in the eleventh row of the 32×32 matrix have the arrangement [32142143 34124123 32142143 34124123], those in the twelfth row of the 32×32 matrix have the arrangement [41233412 21433214 41233412 21433214], those in the 13th row of the 32×32 matrix have the arrangement [21433214 41233412 21433214 41233412], those in the 14th row of the 32×32 matrix have the arrangement [34124123 32142143 34124123 32142143], those in the 15th row of the 32×32 matrix have the arrangement [43211432 23411234 43211432 23411234], those in the 16th row of the 32×32 matrix have the arrangement [12342341 14324321 12342341 14324321], those in the 17th row of the 32×32 matrix have the arrangement [12342341 14324321 12342341 14324321], those in the 18th row of the 32×32 matrix have the arrangement [43211432 23411234 43211432 23411234], those in the 19th row of the 32×32 matrix have the arrangement [34124123 32142143 34124123 32142143], those in the 20th row of the 32×32 matrix have the arrangement [21433214 41233412 21433214 41233412], those in the 21st row of the 32×32 matrix have the arrangement [41233412 21433214 41233412 21433214], those in the 22nd row of the 32×32 matrix have the arrangement [32142143 34124123 32142143 34124123], those in the 23rd row of the 32×32 matrix have the arrangement [23411234 43211432 23411234 43211432], those in the 24th row of the 32×32 matrix have the arrangement [14324321 12342341 14324321 12342341], those in the 25th row of the 32×32 matrix have the arrangement [14324321 12342341 14324321 12342341], those in the 26th row of the 32×32 matrix have the arrangement [23411234 43211432 23411234 43211432], those in the 27th row of the 32×32 matrix have the arrangement [32142143 34124123 32142143 34124123], those in the 28th row of the 32×32 matrix have the arrangement [41233412 21433214 41233412 21433214], those in the 29th row of the 32×32 matrix have the arrangement [21433214 41233412 21433214 41233412], those in the 30th row of the 32×32 matrix have the arrangement [34124123 32142143 34124123 32142143], those in the 31st row of the 32×32 matrix have the arrangement [43211432 23411234 43211432 23411234], those in the 32nd row of the 32×32 matrix have the arrangement [12342341 14324321 12342341 14324321], or
c) the base elements in the first row of the 32×32 matrix have the arrangement [12341234 21432143 12341234 21432143], those in the second row of the 32×32 matrix have the arrangement [43214321 34123412 43214321 34123412], those in the third row of the 32×32 matrix have the arrangement [34123412 43214321 34123412 43214321], those in the fourth row of the 32×32 matrix have the arrangement [21432143 12341234 21432143 12341234], those in the fifth row of the 32×32 matrix have the arrangement [12341234 21432143 12341234 21432143], those in the sixth row of the 32×32 matrix have the arrangement [43214321 34123412 43214321 34123412], the seventh row of the 32×32 matrix have the arrangement [34123412 43214321 34123412 43214321], those in the eighth row of the 32×32 matrix have the arrangement [21432143 12341234 21432143 12341234], those in the ninth row of the 32×32 matrix have the arrangement [43214321 34123412 43214321 34123412], those in the tenth row of the 32×32 matrix have the arrangement [12341234 21432143 12341234 21432143], those in the eleventh row of the 32×32 matrix have the arrangement [21432143 12341234 21432143 12341234], those in the twelfth row of the 32×32 matrix have the arrangement [34123412 43214321 34123412 43214321], those in the 13th row of the 32×32 matrix have the arrangement [43214321 34123412 43214321 34123412], those in the 14th row of the 32×32 matrix have the arrangement [12341234 21432143 12341234 21432143], those in the 15th row of the 32×32 matrix have the arrangement [21432143 12341234 21432143 12341234], those in the 16th row of the 32×32 matrix have the arrangement [34123412 43214321 34123412 43214321], those in the 17th row of the 32×32 matrix have the arrangement [12341234 21432143 12341234 21432143], those in the 18th row of the 32×32 matrix have the arrangement [43214321 34123412 43214321 34123412], those in the 19th row of the 32×32 matrix have the arrangement [34123412 43214321 34123412 43214321], those in the 20th row of the 32×32 matrix have the arrangement [21432143 12341234 21432143 12341234], those in the 21st row of the 32×32 matrix have the arrangement [12341234 21432143 12341234 21432143], those in the 22nd row of the 32×32 matrix have the arrangement [43214321 34123412 43214321 34123412], those in the 23rd row of the 32×32 matrix have the arrangement [34123412 43214321 34123412 43214321], those in the 24th row of the 32×32 matrix have the arrangement [21432143 12341234 21432143 12341234], those in the 25th row of the 32×32 matrix have the arrangement [43214321 34123412 43214321 34123412], those in the 26th row of the 32×32 matrix have the arrangement [12341234 21432143 12341234 21432143], those in the 27th row of the 32×32 matrix have the arrangement [21432143 12341234 21432143 12341234], those in the 28th row of the 32×32 matrix have the arrangement [34123412 43214321 34123412 43214321], those in the 29th row of the 32×32 matrix have the arrangement [43214321 34123412 43214321 34123412], those in the 30th row of the 32×32 matrix have the arrangement [12341234 21432143 12341234 21432143], those in the 31st row of the 32×32 matrix have the arrangement [21432143 12341234 21432143 12341234], those in the 32nd row of the 32×32 matrix have the arrangement [34123412 43214321 34123412 43214321], or
d) the base elements in the first row of the 32×32 matrix have the arrangement [12342341 12342341 12342341 12342341], those in the second row of the 32×32 matrix have the arrangement [43211432 43211432 43211432 43211432], those in the third row of the 32×32 matrix have the arrangement [34124123 34124123 34124123 34124123], those in the fourth row of the 32×32 matrix have the arrangement [21433214 21433214 21433214 21433214], those in the fifth row of the 32×32 matrix have the arrangement [41233412 41233412 41233412 41233412], those in the sixth row of the 32×32 matrix have the arrangement [32142143 32142143 32142143 32142143], those in the seventh row of the 32×32 matrix have the arrangement [23411234 23411234 23411234 23411234], those in the eighth row of the 32×32 matrix have the arrangement [14324321 14324321 14324321 14324321], those in the ninth row of the 32×32 matrix have the arrangement [12342341 12342341 12342341 12342341], those in the tenth row of the 32×32 matrix have the arrangement [43211432 43211432 43211432 43211432], those in the eleventh row of the 32×32 matrix have the arrangement [34124123 34124123 34124123 34124123], those in the twelfth row of the 32×32 matrix have the arrangement [21433214 21433214 21433214 21433214], those in the 13th row of the 32×32 matrix have the arrangement [41233412 41233412 41233412 41233412], those in the 14th row of the 32×32 matrix have the arrangement [32142143 32142143 32142143 32142143], those in the 15th row of the 32×32 matrix have the arrangement [23411234 23411234 23411234 23411234], those in the 16th row of the 32×32 matrix have the arrangement [14324321 14324321 14324321 14324321], those in the 17th row of the 32×32 matrix have the arrangement [12342341 12342341 12342341 12342341], those in the 18th row of the 32×32 matrix have the arrangement [43211432 43211432 43211432 43211432], those in the 19th row of the 32×32 matrix have the arrangement [34124123 34124123 34124123 34124123], those in the 20th row of the 32×32 matrix have the arrangement [21433214 21433214 21433214 21433214], those in the 21st row of the 32×32 matrix have the arrangement [41233412 41233412 41233412 41233412], those in the 22nd row of the 32×32 matrix have the arrangement [32142143 32142143 32142143 32142143], those in the 23rd row of the 32×32 matrix have the arrangement [23411234 23411234 23411234 23411234], those in the 24th row of the 32×32 matrix have the arrangement [14324321 14324321 14324321 14324321], those in the 25th row of the 32×32 matrix have the arrangement [12342341 12342341 12342341 12342341], those in the 26th row of the 32×32 matrix have the arrangement [43211432 43211432 43211432 43211432], those in the 27th row of the 32×32 matrix have the arrangement [34124123 34124123 34124123 34124123], those in the 28th row of the 32×32 matrix have the arrangement [21433214 21433214 21433214 21433214], those in the 29th row of the 32×32 matrix have the arrangement [41233412 41233412 41233412 41233412], those in the 30th row of the 32×32 matrix have the arrangement [32142143 32142143 32142143 32142143], those in the 31st row of the 32×32 matrix have the arrangement [23411234 23411234 23411234 23411234], those in the 32nd row of the 32×32 matrix have the arrangement [14324321 14324321 14324321 14324321], or
e) the base elements in the first row of the 32×32 matrix have the arrangement [12342143 12342143 12342143 12342143], those in the second row of the 32×32 matrix have the arrangement [43213412 43213412 43213412 43213412], those in the third row of the 32×32 matrix have the arrangement [34124321 34124321 34124321 34124321], those in the fourth row of the 32×32 matrix have the arrangement [21431234 21431234 21431234 21431234], those in the fifth row of the 32×32 matrix have the arrangement [43213412 43213412 43213412 43213412], those in the sixth row of the 32×32 matrix have the arrangement [12342143 12342143 12342143 12342143], those in the seventh row of the 32×32 matrix have the arrangement [21431234 21431234 21431234 21431234], those in the eighth row of the 32×32 matrix have the arrangement [34124321 34124321 34124321 34124321], those in the ninth row of the 32×32 matrix have the arrangement [12342341 12342341 12342341 12342341], those in the tenth row of the 32×32 matrix have the arrangement [43213412 43213412 43213412 43213412], those in the eleventh row of the 32×32 matrix have the arrangement [34124321 34124321 34124321 34124321], those in the twelfth row of the 32×32 matrix have the arrangement [21431234 21431234 21431234 21431234], those in the 13th row of the 32×32 matrix have the arrangement [43213412 43213412 43213412 43213412], those in the 14th row of the 32×32 matrix have the arrangement [12342143 12342143 12342143 12342143], those in the 15th row of the 32×32 matrix have the arrangement [21431234 21431234 21431234 21431234], those in the 16th row of the 32×32 matrix have the arrangement [34124321 34124321 34124321 34124321], those in the 17th row of the 32×32 matrix have the arrangement [12342143 12342143 12342143 12342143], those in the 18th row of the 32×32 matrix have the arrangement [43213412 43213412 43213412 43213412], those in the 19th row of the 32×32 matrix have the arrangement [34124321 34124321 34124321 34124321], those in the 20th row of the 32×32 matrix have the arrangement [21431234 21431234 21431234 21431234], those in the 21st row of the 32×32 matrix have the arrangement [43213412 43213412 43213412 43213412], those in the 22nd row of the 32×32 matrix have the arrangement [12342143 12342143 12342143 12342143], those in the 23rd row of the 32×32 matrix have the arrangement [21431234 21431234 21431234 21431234], those in the 24th row of the 32×32 matrix have the arrangement [34124321 34124321 34124321 34124321], those in the 25th row of the 32×32 matrix have the arrangement [12342143 12342143 12342143 12342143], those in the 26th row of the 32×32 matrix have the arrangement [43213412 43213412 43213412 43213412], those in the 27th row of the 32×32 matrix have the arrangement [34124321 34124321 34124321 34124321], those in the 28th row of the 32×32 matrix have the arrangement [21431234 21431234 21431234 21431234], those in the 29th row of the 32×32 matrix have the arrangement [43213412 43213412 43213412 43213412], those in the 30th row of the 32×32 matrix have the arrangement [12342143 12342143 12342143 12342143], those in the 31st row of the 32×32 matrix have the arrangement [21431234 21431234 21431234 21431234], those in the 32nd row of the 32×32 matrix have the arrangement [34124321 34124321 34124321 34124321].

18. The arrangement as claimed in claim 15, wherein to form a complex matrix, a larger array is created from smaller arrays by means of copying, rotation or reflection operations.

19. The arrangement as claimed in claim 16, wherein to form a complex matrix, a larger array is created from smaller arrays by means of copying, rotation or reflection operations.

20. The arrangement as claimed in claim 17, wherein to form a complex matrix, a larger array is created from smaller arrays by means of copying, rotation or reflection operations.

21. The arrangement as claimed in claim 15, wherein individual positions of the arrangement remain unoccupied.

22. The arrangement as claimed in claim 16, wherein individual positions of the arrangement remain unoccupied.

23. The arrangement as claimed in claim 17, wherein individual positions of the arrangement remain unoccupied.

24. An integrated circuit for measuring the polarization of incident light comprising:
polarization-sensitive sensors with polarization planes having at least two different orientations;
devices configured to make a statement about the polarization of the incident light from signals of the polarization-sensitive sensors; and
at least one sensory element which is arranged to cooperate as a structural unit with a polarization filter for one of the polarization-sensitive sensors;
wherein the polarization-sensitive filter of the polarization-sensitive sensor arranged as a structural unit has a specific extension and orientation,
wherein the polarization filter has lattice structures produced by lithographic methods in at least one fabrication layer, and
wherein the polarization-sensitive sensors are arranged with different orientations of the polarization planes as claimed in claim 15.

25. An integrated circuit for measuring the polarization of incident light comprising:
polarization-sensitive sensors with polarization planes having at least two different orientations;
devices configured to make a statement about the polarization of the incident light from signals of the polarization-sensitive sensors; and
at least one sensory element which is arranged to cooperate as a structural unit with a polarization filter for one of the polarization-sensitive sensors;
wherein the polarization-sensitive filter of the polarization-sensitive sensor arranged as a structural unit has a specific extension and orientation,
wherein the polarization filter has lattice structures produced by lithographic methods in at least one fabrication layer, and
wherein the polarization-sensitive sensors are arranged with different orientations of the polarization planes as claimed in claim 16.

26. An integrated circuit for measuring the polarization of incident light comprising:
polarization-sensitive sensors with polarization planes having at least two different orientations;
devices configured to make a statement about the polarization of the incident light from signals of the polarization-sensitive sensors; and
at least one sensory element which is arranged to cooperate as a structural unit with a polarization filter for one of the polarization-sensitive sensors;
wherein the polarization-sensitive filter of the polarization-sensitive sensor arranged as a structural unit has a specific extension and orientation,
wherein the polarization filter has lattice structures produced by lithographic methods in at least one fabrication layer, and
wherein the polarization-sensitive sensors are arranged with different orientations of the polarization planes as claimed in claim 17.

27. An integrated circuit for measuring the polarization of incident light comprising:
at least two polarization-sensitive sensors with different orientation of the polarization planes;
devices configured to make a statement about the polarization of the incident light from signals of the polarization-sensitive sensors;
at least one sensory element which is arranged to cooperate as a structural unit with a polarization filter for one of the polarization-sensitive sensors;
wherein the polarization-sensitive filter of the polarization-sensitive sensor arranged as a structural unit has a specific extension and orientation, wherein the polarization filter has lattice structures produced by lithographic methods in at least one fabrication layer and/or wiring layer,
wherein between regions with the lattice structures there are optically opaque walls present, which prevent interference from adjacent sensors under oblique incident light,
wherein the optically opaque walls are produced by vias or contacts, and
wherein the polarization-sensitive sensors are arranged with different orientations of the polarization planes as claimed in claim 15.

28. An integrated circuit for measuring the polarization of incident light comprising:
at least two polarization-sensitive sensors with different orientation of the polarization planes;
devices configured to make a statement about the polarization of the incident light from signals of the polarization-sensitive sensors;
at least one sensory element which is arranged to cooperate as a structural unit with a polarization filter for one of the polarization-sensitive sensors;
wherein the polarization-sensitive filter of the polarization-sensitive sensor arranged as a structural unit has a specific extension and orientation,
wherein the polarization filter has lattice structures produced by lithographic methods in at least one fabrication layer and/or wiring layer,
wherein between regions with the lattice structures there are optically opaque walls present, which prevent interference from adjacent sensors under oblique incident light,
wherein the optically opaque walls are produced by vias or contacts, and
wherein the polarization-sensitive sensors are arranged with different orientations of the polarization planes as claimed in claim 16.

29. An integrated circuit for measuring the polarization of light comprising:
at least two polarization-sensitive sensors with different orientation of the polarization planes;
devices configured to make a statement about the polarization of incident light from signals of the polarization-sensitive sensors;
at least one sensory element which is arranged to cooperate as a structural unit with a polarization filter for one of the polarization-sensitive sensors;
wherein the polarization-sensitive filter of the polarization-sensitive sensor arranged as a structural unit has a specific extension and orientation,
wherein the polarization filter has lattice structures produced by lithographic methods in at least one fabrication layer and/or wiring layer,
wherein between regions with the lattice structures there are optically opaque walls present, which prevent interference from adjacent sensors under oblique incident light,
wherein the optically opaque walls are produced by vias or contacts, and
wherein the polarization-sensitive sensors are arranged with different orientations of the polarization planes as claimed in claim 17.

30. An integrated circuit for measuring the polarization of incident light comprising:
polarization-sensitive sensors with different orientations of the polarization planes as base elements in four different orientations (1,2,3,4); and
sensory elements, each arranged to cooperate as a structural unit with a polarization filter for one of the polarization-sensitive sensors;
wherein the polarization-sensitive filter of the polarization-sensitive sensor arranged as a structural unit has a specific extension and orientation,
wherein the polarization filter has lattice structures produced by lithographic methods in at least one fabrication layer,
wherein the polarization-sensitive sensors of different orientations consist of a plurality of individual sensor elements arranged in a matrix, wherein in the integrated circuit, devices are provided which are configured to make a statement about the polarization of the incident light from the signals of the polarization-sensitive sensors,
wherein the base elements are arranged with different orientations (1,2,3,4) in an 8×8 matrix, and
wherein the base elements in the first row of the 8×8 matrix have the arrangement [1,2,3,4,2,1,4,3], those in the second row of the 8×8 matrix have the arrangement [4,3,2,1,3,4,1,2], those in the third row of the 8×8 matrix have the arrangement [3,4,1,2,4,3,2,1], those in the fourth row of the 8×8 matrix have the arrangement [2,1,4,3,1,2,3,4], those in the fifth row of the 8×8 matrix have the arrangement [4,3,2,1,3,4,1,2], those in the sixth row of the arrangement have the arrangement [1,2,3,4,2,1,4,3], those in the seventh row of the 8×8 matrix have the arrangement [2,1,4,3,1,2,3,4] and those in the eighth row of the 8×8 matrix have the arrangement [3,4,1,2,4,3,2,1].

31. An integrated circuit for measuring the polarization of incident light comprising:
polarization-sensitive sensors with different orientations of the polarization planes as base elements in four different orientations (1,2,3,4); and
sensory elements, each arranged to cooperate as a structural unit with a polarization filter for one of the polarization-sensitive sensors;
wherein the polarization-sensitive filter of the polarization-sensitive sensor arranged as a structural unit has a specific extension and orientation,
wherein the polarization filter has lattice structures produced by lithographic methods in at least one fabrication layer,
wherein the polarization-sensitive sensors of different orientations consist of a plurality of individual sensor elements arranged in a matrix,
wherein in the integrated circuit, devices are provided which are configured to make a statement about the polarization of the incident light from the signals of the polarization-sensitive sensors,
wherein the base elements are arranged with different orientations (1,2,3,4) in a 16×16 matrix,
wherein
a) the base elements in the first row of the 16×16 matrix have the arrangement [1,2,4,3,2,1,3,4,1,2,4,3,2,1,3,4], those in the second row of the 16×16 matrix have the arrangement [4,3,2,1,3,4,1,2,4,3,2,1,3,4,1,2], those in the third row of the 16×16 matrix have the arrangement [3,4,1,2,4,3,2,1,3,4,1,2,4,3,2,1], those in the fourth row of the 16×16 matrix have the arrangement [2,1,3,4,1,2,4,3,2,1,3,4,1,2,4,3], those in the fifth row of the 16×16 matrix have the arrangement [3,4,2,1,4,3,1,2,3,4,2,1,4,3,1,2], those in the sixth row of the 16×16 matrix have the arrangement [1,2,3,4,2,1,4,3,1,2,3,4,2,1,4,3], those in the seventh row of the 16×16 matrix have the arrangement [2,1,4,3,1,2,3,4,2,1,4,3,1,2,3,4], those in the eighth row of the 16×16 matrix have the arrangement [4,3,1,2,3,4,2,1,4,3,1,2,3,4,2,1], those in the ninth row of the 16×16 matrix have the arrangement [1,2,4,3,2,1,3,4,1,2,4,3,2,1,3,4], those in the tenth row of the 16×16 matrix have the arrangement [4,3,2,1,3,4,1,2,4,3,2,1,3,4,1,2], those in the eleventh row of the 16×16 matrix have the arrangement [3,4,1,2,4,3,2,1,3,4,1,2,4,3,2,1], those in the twelfth row of the 16×16 matrix have the arrangement [2,1,3,4,1,2,4,3,2,1,3,4,1,2,4,3], those in the thirteenth row of the 16×16 matrix have the arrangement [3,4,2,1,4,3,1,2,3,4,2,1,4,3,1,2], those in the fourteenth row of the 16×16 matrix have the arrangement [1,2,3,4,2,1,4,3,1,2,3,4,2,1,4,3], those in the fifteenth row of the 16×16 matrix have the arrangement [2,1,4,3,1,2,3,4,2,1,4,3,1,2,3,4], those in the sixteenth row of the 16×16 matrix have the arrangement [4,3,1,2,3,4,2,1,4,3,1,2,3,4,2,1], or
b) the base elements in the first row of the 16×16 matrix have the arrangement [1,2,3,4,2,3,4,1,1,4,3,2,4,3,2,1], those in the second row of the 16×16 matrix have the arrangement [4,3,2,1,1,4,3,2,2,3,4,1,1,2,3,4], those in the third row of the 16×16 matrix have the arrangement [3,4,1,2,4,1,2,3,3,2,1,4,2,1,4,3], those in the fourth row of the 16×16 matrix have the arrangement [2,1,4,3,3,2,1,4,4,1,2,3,3,4,1,2], those in the fifth row of the 16×16 matrix have the arrangement [4,1,2,3,3,4,1,2,2,1,4,3,3,2,1,4], those in the sixth row of the 16×16 matrix have the arrangement [3,2,1,4,2,1,4,3,3,4,1,2,4,1,2,3], those in the seventh row of the 16×16 matrix have the arrangement [2,3,4,1,1,2,3,4,4,3,2,1,1,4,3,2], those in the eighth row of the 16×16 matrix have the arrangement [1,4,3,2,4,3,2,1,1,2,3,4,2,3,4,1], those in the ninth row of the 16×16 matrix have the arrangement [1,4,3,2,4,3,2,1,1,2,3,4,2,3,4,1], those in the tenth row of the 16×16 matrix have the arrangement [2,3,4,1,1,2,3,4,4,3,2,1,1,4,3,2], those in the eleventh row of the 16×16 matrix have the arrangement [3,2,1,4,2,1,4,3,3,4,1,2,4,1,2,3], those in the twelfth row of the 16×16 matrix have the arrangement [4,1,2,3,3,4,1,2,2,1,4,3,3,2,1,4], those in the thirteenth row of the 16×16 matrix have the arrangement [2,1,4,3,3,2,1,4,4,1,2,3,3,4,1,2], those in the fourteenth row of the 16×16 matrix have the arrangement [3,4,1,2,4,1,2,3,3,2,1,4,2,1,4,3], those in the fifteenth row of the 16×16 matrix have the arrangement [4,3,2,1,1,4,3,2,2,3,4,1,1,2,3,4], those in the sixteenth row of the 16×16 matrix have the arrangement [1,2,3,4,2,3,4,1,1,4,3,2,4,3,2,1], or
c) the base elements in the first row of the 16×16 matrix have the arrangement [1,2,3,4,1,2,3,4,1,2,3,4,1,2,3,4], those in the second row of the 16×16 matrix have the arrangement [4,3,2,1,4,3,2,1,4,3,2,1,4,3,2,1], those in the third row of the 16×16 matrix have the arrangement [3,4,1,2,3,4,1,2,3,4,1,2,3,4,1,2], those in the fourth row of the 16×16 matrix have the arrangement [2,1,4,3,2,1,4,3,2,1,4,3,2,1,4,3], those in the fifth row of the 16×16 matrix have the arrangement [1,2,3,4,1,2,3,4,1,2,3,4,1,2,3,4], those in the sixth row of the 16×16 matrix have the arrangement [4,3,2,1,4,3,2,1,4,3,2,1,4,3,2,1], those in the seventh row of the 16×16 matrix have the arrangement [3,4,1,2,3,4,1,2,3,4,1,2,3,4,1,2], those in the eighth row of the 16×16 matrix have the arrangement [2,1,4,3,2,1,4,3,2,1,4,3,2,1,4,3], those in the ninth row of the 16×16 matrix have the arrangement [1,2,3,4,1,2,3,4,1,2,3,4,1,2,3, 4], those in the tenth row of the 16×16 matrix have the arrangement [4,3,2,1,4,3,2,1,4,3,2,1,4,3,2,1], those in the eleventh row of the 16×16 matrix have the arrangement [3,4,1,2,3,4,1,2,3,4,1,2,3,4,1,2], those in the twelfth row of the 16×16 matrix have the arrangement [2,1,4,3,2,1,4,3,2,1,4,3,2,1,4,3], those in the thirteenth row of the 16×16 matrix have the arrangement [1,2,3,4,1,2,3,4,1,2,3,4,1,2,3,4], those in the fourteenth row of the 16×16 matrix have the arrangement [4,3,2,1,4,3,2,1,4,3,2,1,4,3,2,1], those in the fifteenth row of the 16×16 matrix have the arrangement [3,4,1,2,3,4,1,2,3,4,1,2,3,4,1,2], those in the sixteenth row of the 16×16 matrix have the arrangement [2,1,4,3,2,1,4,3,2,1,4,3,2,1,4,3], or
d) the base elements in the first row of the 16×16 matrix have the arrangement [1,2,3,4,2,1,4,3,1,2,3,4,2,1,4,3], those in the second row of the 16×16 matrix have the arrangement [4,3,2,1,3,4,1,2,4,3,2,1,3,4,1,2], those in the third row of the 16×16 matrix have the arrangement [3,4,1,2,4,3,2,1, 3,4,1,2,4,3,2,1], those in the fourth row of the 16×16 matrix have the arrangement [2,1,4,3,1,2,3,4,2,1,4,3,1,2,3,4], those in the fifth row of the 16×16 matrix have the arrangement [4,3,2,1,3,4,1,2,4,3,2,1,3,4,1,2], those in the sixth row of the 16×16 matrix have the arrangement [1,2,3,4,2,1,4,3,1,2,3,4,2,1,4,3], those in the seventh row of the 16×16 matrix have the arrangement [2,1,4,3,1,2,3,4,2,1,4,3,1,2,3,4], those in the eighth row of the 16×16 matrix have the arrangement [3,4,1,2,4,3,2,1,3,4,1,2,4,3,2,1], those in the ninth row of the 16×16 matrix have the arrangement [1,2,3,4,2,1,4,3,1,2,3,4,2,1,4,3], those in the tenth row of the 16×16 matrix have the arrangement [4,3,2,1,3,4,1,2,4,3,2,1,3,4,1,2], those in the eleventh row of the 16×16 matrix have the arrangement [3,4,1,2,4,3,2,1,3,4,1,2,4,3,2,1], those in the twelfth row of the 16×16 matrix have the arrangement [2,1,4,3,1,2,3,4,2,1,4,3,1,2,3,4], those in the thirteenth row of the 16×16 matrix have the arrangement [4,3,2,1,3,4,1,2 4,3,2,1,3,4,1,2], those in the fourteenth row of the 16×16 matrix have the arrangement [1,2,3,4,2,1,4,3,1,2,3,4,2,1,4,3], those in the fifteenth row of the 16×16 matrix have the arrangement [2,1,4,3,1,2,3,4,2,1,4,3,1,2,3,4], those in the sixteenth row of the 16×16 matrix have the arrangement [3,4,1,2,4,3,2,1,3,4,1,2,4,3,2,1].

32. An integrated circuit for measuring the polarization of light comprising:
polarization-sensitive sensors with different orientations of the polarization planes as base elements in four different orientations (1,2,3,4); and
sensory elements, each arranged to cooperate as a structural unit with a polarization filter for one of the polarization-sensitive sensors;
wherein the polarization-sensitive filter of the polarization-sensitive sensor arranged as a structural unit has a specific extension and orientation,
wherein the polarization filter has lattice structures produced by lithographic methods in at least one fabrication layer,
wherein the polarization-sensitive sensors of different orientations consist of a plurality of individual sensor elements arranged in a matrix, wherein in the integrated circuit, devices are provided which are configured to make a statement about the polarization of the incident light from the signals of the polarization-sensitive sensors,
wherein the base elements are arranged with different orientations (1,2,3,4) in a 32×32 matrix,
wherein:
a) the base elements in the first row of the 32×32 matrix have the arrangement [12341234 21432143 12341234 23412341], those in the second row of the 32×32 matrix have the arrangement [43214321 14321432 43214321 14321432], those in the third row of the 32×32 matrix have the arrangement [34123412 41234123 34123412 41234123], those in the fourth row of the 32×32 matrix have the arrangement [21432143 32143214 21432143 32143214], those in the fifth row of the 32×32 matrix have the arrangement [12341234 23412341 12341234 23412341], those in the sixth row of the 32×32 matrix have the arrangement [43214321 14321432 43214321 14321432], those in the seventh row of the 32×32 matrix have the arrangement [34123412 41234123 34123412 41234123], those in the eighth row of the 32×32 matrix have the arrangement [21432143 32143214 21432143 32143214], those in the ninth row of the 32×32 matrix have the arrangement [41234123 34123412 41234123 34123412], those in the tenth row of the 32×32 matrix have the arrangement [32143214 21432143 32143214 21432143], those in the eleventh row of the 32×32 matrix have the arrangement [23412341 12341234 23412341 12341234], those in the twelfth row of the 32×32 matrix have the arrangement [14321432 43214321 14321432 43214321], those in the 13th row of the 32×32 matrix have the arrangement [41234123 34123412 41234123 34123412], those in the 14th row of the 32×32 matrix have the arrangement [32143214 21432143 32143214 21432143], those in the 15th row of the 32×32 matrix have the arrangement [23412341 12341234 23412341 12341234], those in the 16th row of the 32×32 matrix have the arrangement [14321432 43214321 14321432 43214321], those in the 17th row of the 32×32 matrix have the arrangement [12341234 23412341 12341234 23412341], those in the 18th row of the 32×32 matrix have the arrangement [43214321 14321432 43214321 14321432], those in the 19th row of the 32×32 matrix have the arrangement [34123412 41234123 34123412 41234123], those in the 20th row of the 32×32 matrix have the arrangement [21432143 32143214 21432143 32143214], those in the 21st row of the 32×32 matrix have the arrangement [12341234 23412341 12341234 23412341], those in the 22nd row of the 32×32 matrix have the arrangement [43214321 14321432 43214321 14321432], those in the 23rd row of the 32×32 matrix have the arrangement [34123412 41234123 34123412 41234123], those in the 24th row of the 32×32 matrix have the arrangement [21432143 32143214 21432143 32143214], those in the 25th row of the 32×32 matrix have the arrangement [41234123 34123412 41234123 34123412], those in the 26th row of the 32×32 matrix have the arrangement [32143214 21432143 32143214 21432143], those in the 27th row of the 32×32 matrix have the arrangement [23412341 12341234 23412341 12341234], those in the 28th row of the 32×32 matrix have the arrangement [14321432 43214321 14321432 43214321], those in the 29th row of the 32×32 matrix have the arrangement [41234123 34123412 41234123 34123412], those in the 30th row of the 32×32 matrix have the arrangement [32143214 21432143 32143214 21432143], those in the 31st row of the 32×32 matrix have the arrangement [23412341 12341234 23412341 12341234], those in the 32nd row of the 32×32 matrix have the arrangement [14321432 43214321 14321432 43214321], or
b) the base elements in the first row of the 32×32 matrix have the arrangement [12342341 14324321 12342341 14324321], those in the second row of the 32×32 matrix have the arrangement [43211432 23411234 43211432 23411234], those in the third row of the 32×32 matrix have the arrangement [34123412 41234123 34123412 34123412], those in the fourth row of the 32×32 matrix have the arrangement [21433214 41233412 21433214 41233412], those in the fifth row of the 32×32 matrix have the arrangement [41233412 21433214 41233412 21433214], those in the sixth row of the 32×32 matrix have the arrangement [32142143 34124123 32142143 34124123], those in the seventh row of the 32×32 matrix have the arrangement [23411234 43211432 23411234 43211432] those in the eighth row of the 32×32 matrix have the arrangement [14324321 12342341 14324321 12342341], those in the ninth row of the 32×32 matrix have the arrangement [14324321 12342341 14324321 12342341], those in the tenth row of the 32×32 matrix have the arrangement [23411234 43211432 23411234 43211432], those in the eleventh row of the 32×32 matrix have the arrangement [32142143 34124123 32142143 34124123], those in the twelfth row of the 32×32 matrix have the arrangement [41233412 21433214 41233412 21433214], those in the 13th row of the 32×32 matrix have the arrangement [21433214 41233412 21433214 41233412], those in the 14th row of the 32×32 matrix have the arrangement [34124123 32142143 34124123 32142143], those in the 15th row of the 32×32 matrix have the arrangement [43211432 23411234 43211432 23411234], those in the 16th row of the 32×32 matrix have the arrangement [12342341 14324321 12342341 14324321], those in the 17th row of the 32×32 matrix have the arrangement [12342341 14324321 12342341 14324321], those in the 18th row of the 32×32 matrix have the arrangement [43211432 23411234 43211432 23411234], those in the 19th row of the 32×32 matrix have the arrangement [34124123 32142143 34124123 32142143], those in the 20th row of the 32×32 matrix have the arrangement [21433214 41233412 21433214 41233412], those in the 21st row of the 32×32 matrix have the arrangement [41233412 21433214 41233412 21433214], those in the 22nd row of the 32×32 matrix have the arrangement [32142143 34124123 32142143 34124123], those in the 23rd row of the 32×32 matrix have the arrangement [23411234 43211432 23411234 43211432], those in the 24th row of the 32×32 matrix have the arrangement [14324321 12342341 14324321 12342341], those in the 25th row of the 32×32 matrix have the arrangement [14324321 12342341 14324321 12342341], those in the 26th row of the 32×32 matrix have the arrangement [23411234 43211432 23411234 43211432], those in the 27th row of the 32×32 matrix have the arrangement [32142143 34124123 32142143 34124123], those in the 28th row of the 32×32 matrix have the arrangement [41233412 21433214 41233412 21433214], those in the 29th row of the 32×32 matrix have the arrangement [21433214 41233412 21433214 41233412], those in the 30th row of the 32×32 matrix have the arrangement [34124123 32142143 34124123 32142143], those in the 31st row of the 32×32 matrix have the arrangement [43211432 23411234 43211432 23411234], those in the 32nd row of the 32×32 matrix have the arrangement [12342341 14324321 12342341 14324321], or
c) the base elements in the first row of the 32×32 matrix have the arrangement [12341234 21432143 12341234 21432143], those in the second row of the 32×32 matrix have the arrangement [43214321 34123412 43214321 34123412], those in the third row of the 32×32 matrix have the arrangement [34123412 43214321 34123412 43214321], those in the fourth row of the 32×32 matrix have the arrangement [21432143 12341234 21432143 12341234], those in the fifth row of the 32×32 matrix have the arrangement [12341234 21432143 12341234 21432143], those in the sixth row of the 32×32 matrix have the arrangement [43214321 34123412 43214321 34123412], those in the seventh row of the 32×32 matrix have the arrangement [34123412 43214321 34123412 43214321], those in the eighth row of the 32×32 matrix have the arrangement [21432143 12341234 21432143 12341234], those in the ninth row of the 32×32 matrix have the arrangement [43214321 34123412 43214321 34123412], those in the tenth row of the 32×32 matrix have the arrangement [12341234 21432143 12341234 21432143], those in the eleventh row of the 32×32 matrix have the arrangement [21432143 12341234 21432143 12341234], those in the twelfth row of the 32×32 matrix have the arrangement [34123412 43214321 34123412 43214321], those in the 13th row of the 32×32 matrix have the arrangement [43214321 34123412 43214321 34123412], those in the 14th row of the 32×32 matrix have the arrangement [12341234 21432143 12341234 21432143], those in the 15th row of the 32×32 matrix have the arrangement [21432143 12341234 21432143 12341234], those in the 16th row of the 32×32 matrix have the arrangement [34123412 43214321 34123412 43214321], those in the 17th row of the 32×32 matrix have the arrangement [12341234 21432143 12341234 21432143], those in the 18th row of the 32×32 matrix have the arrangement [43214321 34123412 43214321 34123412], those in the 19th row of the 32×32 matrix have the arrangement [34123412 43214321 34123412 43214321], those in the 20th row of the 32×32 matrix have the arrangement [21432143 12341234 21432143 12341234], those in the 21st row of the 32×32 matrix have the arrangement [12341234 21432143 12341234 21432143], those in the 22nd row of the 32×32 matrix have the arrangement [43214321 34123412 43214321 34123412], those in the 23rd row of the 32×32 matrix have the arrangement [34123412 43214321 34123412 43214321], those in the 24th row of the 32×32 matrix have the arrangement [21432143 12341234 21432143 12341234], those in the 25th row of the 32×32 matrix have the arrangement [43214321 34123412 43214321 34123412], those in the 26th row of the 32×32 matrix have the arrangement [12341234 21432143 12341234 21432143], those in the 27th row of the 32×32 matrix have the arrangement [21432143 12341234 21432143 12341234], those in the 28th row of the 32×32 matrix have the arrangement [34123412 43214321 34123412 43214321], those in the 29th row of the 32×32 matrix have the arrangement [43214321 34123412 43214321 34123412], those in the 30th row of the 32×32 matrix have the arrangement [12341234 21432143 12341234 21432143], those in the 31st row of the 32×32 matrix have the arrangement [21432143 12341234 21432143 12341234], those in the 32nd row of the 32×32 matrix have the arrangement [34123412 43214321 34123412 43214321], or
d) the base elements in the first row of the 32×32 matrix have the arrangement [12342341 12342341 12342341 12342341], those in the second row of the 32×32 matrix have the arrangement [43211432 43211432 43211432 43211432], those in the third row of the 32×32 matrix have the arrangement [34124123 34124123 34124123 34124123], those in the fourth row of the 32×32 matrix have the arrangement [21433214 21433214 21433214 21433214], those in the fifth row of the 32×32 matrix have the arrangement [41233412 41233412 41233412 41233412], those in the sixth row of the 32×32 matrix have the arrangement [32142143 32142143 32142143 32142143], those in the seventh row of the 32×32 matrix have the arrangement [23411234 23411234 23411234 23411234], those in the eighth row of the 32×32 matrix have the arrangement [14324321 14324321 14324321 14324321], those in the ninth row of the 32×32 matrix have the arrangement [12342341 12342341 12342341 12342341], those in the tenth row of the 32×32 matrix have the arrangement [43211432 43211432 43211432 43211432], those in the eleventh row of the 32×32 matrix have the arrangement [34124123 34124123 34124123 34124123], those in the twelfth row of the 32×32 matrix have the arrangement [21433214 21433214 21433214 21433214], those in the 13th row of the 32×32 matrix have the arrangement [41233412 41233412 41233412 41233412], those in the 14th row of the 32×32 matrix have the arrangement [32142143 32142143 32142143 32142143], those in the 15th row of the 32×32 matrix have the arrangement [23411234 23411234 23411234 23411234], those in the 16th row of the 32×32 matrix have the arrangement [14324321 14324321 14324321 14324321], those in the 17th row of the 32×32 matrix have the arrangement [12342341 12342341 12342341 12342341], those in the 18th row of the 32×32 matrix have the arrangement [43211432 43211432 43211432 43211432], those in the 19th row of the 32×32 matrix have the arrangement [34124123 34124123 34124123 34124123], those in the 20th row of the 32×32 matrix have the arrangement [21433214 21433214 21433214 21433214], those in the 21st row of the 32×32 matrix have the arrangement [41233412 41233412 41233412 41233412], those in the 22nd row of the 32×32 matrix have the arrangement [32142143 32142143 32142143 32142143], those in the 23rd row of the 32×32 matrix have the arrangement [23411234 23411234 23411234 23411234], those in the 24th row of the 32×32 matrix have the arrangement [14324321 14324321 14324321 14324321], those in the 25th row of the 32×32 matrix have the arrangement [12342341 12342341 12342341 12342341], those in the 26th row of the 32×32 matrix have the arrangement [43211432 43211432 43211432 43211432], those in the 27th row of the 32×32 matrix have the arrangement [34124123 34124123 34124123 34124123], those in the 28th row of the 32×32 matrix have the arrangement [21433214 21433214 21433214 21433214], those in the 29th row of the 32×32 matrix have the arrangement [41233412 41233412 41233412 41233412], those in the 30th row of the 32×32 matrix have the arrangement [32142143 32142143 32142143 32142143], those in the 31st row of the 32×32 matrix have the arrangement [23411234 23411234 23411234 23411234], those in the 32nd row of the 32×32 matrix have the arrangement [14324321 14324321 14324321 14324321], or
e) the base elements in the first row of the 32×32 matrix have the arrangement [12342143 12342143 12342143 12342143], those in the second row of the 32×32 matrix have the arrangement [43213412 43213412 43213412 43213412], those in the third row of the 32×32 matrix have the arrangement [34124321 34124321 34124321 34124321], those in the fourth row of the 32×32 matrix have the arrangement [21431234 21431234 21431234 21431234], those in the fifth row of the 32×32 matrix have the arrangement [43213412 43213412 43213412 43213412], those in the sixth row of the 32×32 matrix have the arrangement [12342143 12342143 12342143 12342143], those in the seventh row of the 32×32 matrix have the arrangement [21431234 21431234 21431234 21431234], those in the eighth row of the 32×32 matrix have the arrangement [34124321 34124321 34124321 34124321], those in the ninth row of the 32×32 matrix have the arrangement [12342341 12342341 12342341 12342341], those in the tenth row of the 32×32 matrix have the arrangement [43213412 43213412 43213412 43213412], those in the eleventh row of the 32×32 matrix have the arrangement [34124321 34124321 34124321 34124321], those in the twelfth row of the 32×32 matrix have the arrangement [21431234 21431234 21431234 21431234], those in the 13th row of the 32×32 matrix have the arrangement [43213412 43213412 43213412 43213412], those in the 14th row of the 32×32 matrix have the arrangement [12342143 12342143 12342143 12342143], those in the 15th row of the 32×32 matrix have the arrangement [21431234 21431234 21431234 21431234], those in the 16th row of the 32×32 matrix have the arrangement [34124321 34124321 34124321 34124321], those in the 17th row of the 32×32 matrix have the arrangement [12342143 12342143 12342143 12342143], those in the 18th row of the 32×32 matrix have the arrangement [43213412 43213412 43213412 43213412], those in the 19th row of the 32×32 matrix have the arrangement [34124321 34124321 34124321 34124321], those in the 20th row of the 32×32 matrix have the arrangement [21431234 21431234 21431234 21431234], those in the 21st row of the 32×32 matrix have the arrangement [43213412 43213412 43213412 43213412], those in the 22nd row of the 32×32 matrix have the arrangement [12342143 12342143 12342143 12342143], those in the 23rd row of the 32×32 matrix have the arrangement [21431234 21431234 21431234 21431234], those in the 24th row of the 32×32 matrix have the arrangement [34124321 34124321 34124321 34124321], those in the 25th row of the 32×32 matrix have the arrangement [12342143 12342143 12342143 12342143], those in the 26th row of the 32×32 matrix have the arrangement [43213412 43213412 43213412 43213412], those in the 27th row of the 32×32 matrix have the arrangement [34124321 34124321 34124321 34124321], those in the 28th row of the 32×32 matrix have the arrangement [21431234 21431234 21431234 21431234], those in the 29th row of the 32×32 matrix have the arrangement [43213412 43213412 43213412 43213412], those in the 30th row of the 32×32 matrix have the arrangement [12342143 12342143 12342143 12342143], those in the 31st row of the 32×32 matrix have the arrangement [21431234 21431234 21431234 21431234], those in the 32nd row of the 32×32 matrix have the arrangement [34124321 34124321 34124321 34124321].

33. An integrated circuit for measuring the polarization of light as claimed in claim 30, wherein individual positions of the arrangement remain unoccupied.

34. An integrated circuit for measuring the polarization of light as claimed in claim 31, wherein individual positions of the arrangement remain unoccupied.

35. An integrated circuit for measuring the polarization of light as claimed in claim 32, wherein individual positions of the arrangement remain unoccupied.

36. An integrated circuit for measuring the polarization of light as claimed in claim 30, wherein:
the polarization filter has lattice structures produced by lithographic methods in at least one fabrication layer and/or wiring layer,
between regions with lattice structures there are optically opaque walls present, which prevent interference from adjacent sensors under oblique incident light, and
the optically opaque walls are produced by vias or contacts.

37. An integrated circuit for measuring the polarization of light as claimed in claim 31, wherein:
the polarization filter has lattice structures produced by lithographic methods in at least one fabrication layer and/or wiring layer,
between regions with lattice structures there are optically opaque walls present, which prevent interference from adjacent sensors under oblique incident light, and
the optically opaque walls are produced by vias or contacts.

38. An integrated circuit for measuring the polarization of light as claimed in claim 32, wherein:
the polarization filter has lattice structures produced by lithographic methods in at least one fabrication layer and/or wiring layer,
between regions with lattice structures there are optically opaque walls present, which prevent interference from adjacent sensors under oblique incident light, and
the optically opaque walls are produced by vias or contacts.
